(19) United States
(12) Patent Application Publication
(10) Pub. No.: US 2019/0354116 A1
(43) Pub. Date: Nov. 21, 2019

(54) TRAJECTORY DETERMINATION IN A DRONE RACE

(71) Applicant: QUALCOMM Incorporated, San Diego, CA (US)

(72) Inventors: Michael Joshua Shomin, Philadelphia, PA (US); Paul Daniel Martin, Philadelphia, PA (US); Ross Eric Kessler, Philadelphia, PA (US); Matthew Hyatt Turpin, Philadellphia, PA (US); Stephen Marc Chaves, Philadelphia, PA (US); Daniel Warren Mellinger, III, Philadelphia, CA (US)

(21) Appl. No.: 15/984,181

(22) Filed: May 18, 2018

(51) Int. Cl. G05D 1/10; G05D 1/00; G05D 1/08; G05D 1/04; G08G 5/04; A63H 27/00

(52) U.S. Cl. CPC G05D 1/101; G05D 1/0011; G05D 1/0808; G05D 1/042; G08G 5/045; B64C 39/024; A63H 27/12; B64C 2201/146; B64C 2201/145; B64C 2201/066; G05D 1/0088

(57) ABSTRACT

Aspects may provide navigation assistance to guide a robotic vehicle through a course defined by a plurality of gates each including a fiducial marker that encodes a location, an ordering, and a pose of the corresponding gate. In some implementations, an optimal trajectory may be generated through the course and used to determine whether to provide navigation assistance to the robotic vehicle. The optimal trajectory may include a reference path that extends through openings formed in center portions of the gates, and may be used to create a virtual tunnel indicating a maximum distance that the robotic vehicle may deviate from various points along the reference path. If the robotic vehicle deviates from the optimal trajectory by more than the distance while traversing the course, navigation assistance may be provided to the robotic vehicle.

### DESCRIPTION OF THE RELATED TECHNOLOGY

A robotic vehicle, such as an unmanned autonomous vehicle (UAV) or drone, may be used in a wide variety of commercial applications including, for example, delivering goods and medicine, geographic topology surveying, reconnaissance, weather reporting, and many others. Robotic vehicles may also be used for recreational purposes, both for amateur users and professional racers. For example, first person view (FPV) drone racing is a relatively new sport in which expert pilots navigate drones or UAVs through race courses. A pilot typically uses streaming video provided by the drone's camera to navigate the drone around the various gates that define the race course. Latencies and jitter in the streaming video transmitted from the drone may decrease the pilot's margin of error when traversing the race course, particularly at high speeds and during sharp turns. Crashes can be relatively frequent, and the races are relatively short (such as less than a few minutes) due to limited battery resources of the drones. The level of skill and experience required to pilot drones in these races are a significant barrier to entry for many people, which may undesirably slow widespread adoption of drone racing as a sport.

### SUMMARY

The systems, methods and devices of this disclosure each have several innovative aspects, no single one of which is solely responsible for the desirable attributes disclosed herein.

One innovative aspect of the subject matter described in this disclosure may be implemented in a system for guiding a robotic vehicle through a course. In some implementations, the system may include one or more processors and a memory. The memory may store instructions that, when executed by the one or more processors, causes the system to perform a number of operations. The number of operations may include at least determining gate information for each of a plurality of gates that define the course, the gate information including at least a location, an ordering, and a pose of each gate; determining a number of capabilities of the robotic vehicle; and generating an optimal trajectory through the course based on the determined gate information and the determined capabilities, the optimal trajectory including a reference path for the robotic vehicle to follow through the course. The system may also include a wireless transceiver coupled to the one or more processors and configured to transmit the optimal trajectory to the robotic vehicle. In addition, or in the alternative, the optimal trajectory may be defined as a function of time, for example, so that the actual flight path of the robotic vehicle may be compared with the optimal trajectory at selected instances of time, during selected periods of time, or continuously, and so that navigation assistance may be determined for the robotic vehicle in real-time.

In some implementations, the number of operations may also include determining that a selected robotic vehicle has deviated from the optimal trajectory by more than a distance, and providing navigation assistance to the selected robotic vehicle based at least in part on the determined deviation. In some aspects, deviations between the selected robotic vehicle's actual flight path and the optimal trajectory may be determined, at least in part, as a function of both time and distance. The navigation assistance may be configured to cause the selected robotic vehicle to change one or more of its velocity, altitude, direction, pose, and turning characteristics so that the flight path of the selected robotic vehicle converges with the optimal trajectory. In some aspects, a first level of navigation assistance may be provided to the selected robotic vehicle based on a first type of race, and a second level of navigation assistance, different than the first level of navigation assistance, may be provided to the selected robotic vehicle based on a second type of race. The first level of navigation assistance may include assuming control of the selected robotic vehicle or causing the selected robotic vehicle to stop, land, or return home; and the second level of navigation assistance may include changing a velocity, altitude, direction, and/or pose of the selected robotic vehicle.

In some implementations, the number of operations may also include determining a skill level and one or more preferences of a pilot associated with the selected robotic vehicle, and modifying the optimal trajectory based at least in part on the determined skill level and preferences. The one or more preferences may include at least one of a risk level of the pilot and a desired competitive level of the pilot.

In some implementations, the number of operations may also include detecting a presence of another robotic vehicle within a distance of the selected robotic vehicle, and modifying the optimal trajectory based on the detected presence of the other robotic vehicle. The modified optimal trajectory may be configured to avoid a collision between the selected robotic vehicle and the other robotic vehicle.

In some implementations, the number of operations may also include determining one or more race hazards, and modifying the optimal trajectory based on the determined race hazards. The one or more race hazards may include at least one of a crash on the course, a presence of obstacles on the course, and a change in capabilities of the selected robotic vehicle.

Another innovative aspect of the subject matter described in this disclosure is a method for guiding a robotic vehicle through a course. In some implementations, the method may include determining gate information for each of a plurality of gates that define the course; determining a number of capabilities of a selected robotic vehicle; generating an optimal trajectory through the course based on the determined gate information and the determined capabilities; and providing the optimal trajectory to the selected robotic vehicle. The optimal trajectory may include a reference path for the selected robotic vehicle to follow through the course, and may include a virtual tunnel oriented around the reference path and may be configured to indicate a distance that the selected robotic vehicle may deviate from various points along the reference path. In some aspects, the optimal trajectory may include one or more of position information, velocity information, acceleration information, altitude information, pose information, and turning characteristics for the selected robotic vehicle. The turning characteristics may refer to one or more rotational aspects of the selected robotic vehicle associated with changing its flight path such as, for example, pitch, roll, and yaw.

The method may also include determining that the selected robotic vehicle has deviated from the optimal trajectory by more than the distance, and providing navigation assistance to the selected robotic vehicle based at least in part on the determined deviation. In some aspects, deviations between the selected robotic vehicle's actual flight path and the optimal trajectory may be determined, at least in part, as a function of both time and distance. The navigation assistance may be configured to cause the selected robotic vehicle to change one or more of its velocity, altitude, direction, pose, and turning characteristics so that the flight path of the selected robotic vehicle converges with the optimal trajectory. In some aspects, a first level of navigation assistance may be provided to the selected robotic vehicle based on a first type of race, and a second level of navigation assistance, different than the first level of navigation assistance, may be provided to the selected robotic vehicle based on a second type of race. The first level of navigation assistance may include assuming control of the selected robotic vehicle or causing the selected robotic vehicle to stop, land, or return home; the second level of navigation assistance may include changing a velocity, altitude, direction, and/or pose of the selected robotic vehicle.

The method may also include determining a skill level and one or more preferences of a pilot associated with the selected robotic vehicle, and modifying the optimal trajectory based at least in part on the determined skill level and preferences. In some aspects, the one or more preferences may include at least one of a risk level of the pilot and a desired competitive level of the pilot.

The method may also include detecting a presence of another robotic vehicle within a distance of the selected robotic vehicle, and modifying the optimal trajectory based on the detected presence of the other robotic vehicle. The modified optimal trajectory may be configured to avoid a collision between the selected robotic vehicle and the other robotic vehicle.

The method may also include determining one or more race hazards, and modifying the optimal trajectory based on the determined race hazards. In some aspects, the one or more race hazards may include at least one of a crash on the course, a presence of obstacles on the course, and a change in capabilities of the selected robotic vehicle.

### BRIEF DESCRIPTION OF THE DRAWINGS

FIG. 1 is a block diagram of an example robotic vehicle suitable for use in various embodiments.

FIG. 2 is a block diagram of an example race course within which various embodiments may be implemented.

FIG. 3A shows an illustration depicting two example fiducial gates in accordance with some embodiments.

FIG. 3B shows an illustration depicting two example fiducial gates in accordance with some embodiments.

FIG. 4A shows an illustration depicting a pilot controlling operations of a robotic vehicle using a vehicle controller according to various embodiments.

FIG. 4B is a block diagram of a vehicle controller suitable for use in various embodiments.

FIG. 5 is a block diagram of a system controller suitable for managing various operations related to a race course, the gates that define the race course, a number of robotic vehicles participating in a race, and/or the pilots of the robotic vehicles according to various embodiments.

FIG. 6 shows an illustration depicting an example optimal trajectory that may be created for a race course according to various embodiments.

FIG. 7A shows an illustration depicting an example field of view of a pilot of a robotic vehicle according to various embodiments.

FIG. 7B shows an illustration depicting an example virtual arrow that may be presented on a display of a robotic vehicle controller according to various embodiments.

FIG. 7C shows an illustration depicting two example virtual objects that may be presented on a display of a robotic vehicle controller according to various embodiments.

FIG. 7D shows an illustration depicting a virtual contact between the robotic vehicle and a virtual obstacle according to various embodiments.

FIG. 8A shows an illustrative flow chart depicting an example operation for implementing a race course according to various embodiments.

FIG. 8B shows an illustrative flow chart depicting an example operation for implementing a race between robotic vehicles according to various embodiments.

FIGS. 9A-9D show illustrative flow charts depicting example operations for guiding a robotic vehicle through a race course according to various embodiments.

FIG. 10 shows an illustrative flow chart depicting an example operation for augmenting a race between a plurality of robotic vehicles with one or more virtual reality features according to various embodiments.

FIG. 11 is a component block diagram of a robotic vehicle, such as an aerial UAV, suitable for use with various embodiments.

FIG. 12 is a component block diagram illustrating a processing device suitable for implementing various embodiments.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. References made to particular examples and implementations are for illustrative purposes, and are not to be construed as limiting the scope of the claims.

Robotic vehicles such as UAVs or drones may be used for recreational purposes. For example, drone racing is a relatively new sport in which pilots navigate UAVs through race courses using streaming video that provides a first-person view of the UAVs. Latencies and jitter in the streaming video transmitted from a UAV may decrease the pilot's margin of error, particularly when the UAV is operated at high speeds and through tight turns. Drone races are relatively short (such as less than a few minutes) due to limited battery resources of the UAVs, and often involve collisions and crashes. The level of skill and experience required to pilot a UAV in drone races may be a significant barrier to entry for many people.

Aspects of the present disclosure may provide navigation assistance to guide a robotic vehicle through a course defined by a plurality of gates, where each of the gates displays a fiducial marker that encodes gate information including a location, an ordering, and a pose of the corresponding gate. In some implementations, an optimal trajectory may be generated through the race course and used to determine whether to provide navigation assistance to the robotic vehicle. The optimal trajectory may include a reference path that extends through openings formed in center portions of the gates, and may be used to create a virtual tunnel indicating a maximum distance that the robotic vehicle may deviate from various points along the reference path.

The dynamics of robotic vehicles such as UAVs may be very complex, especially at high speeds, and the full states (such as position, velocity, altitude, and pose—as well as a number of derivatives thereof) of all UAVs participating in a race may be required to predict collisions between the UAVs. Although forward simulation techniques may be used to predict or determine when to assume control of one or more of the UAVs to prevent such collisions, for purposes of discussion herein, deviations of the UAVs from an optimal trajectory are based on “distances” to avoid unnecessarily obfuscating aspects of this disclosure. However, one of ordinary skill in the art will understand that the “distances” as used herein with respect to determining whether a particular UAV has deviated from the optimal trajectory may refer to, or be indicative of, the full states of the UAVs.

In some implementations, the optimal trajectory may be defined as a function of time so that a particular robotic vehicle may compare, at any instant in time (or for any period of time), its actual position, velocity, acceleration, altitude, and pose with the position information, velocity information, acceleration information, altitude information, and pose information defined by the optimal trajectory. As used herein, the term “velocity information” may include linear velocity and/or angular velocity information, and the term “acceleration information” may include linear acceleration and/or angular acceleration information. Also, as used herein, the term “turning characteristics” may refer to the rotational abilities of a robotic vehicle when turning or changing a flight direction. In some aspects, the rotational abilities of a robotic vehicle may refer to the robotic vehicle's ability to pitch (such as rotating the robotic vehicle about the horizontal axis perpendicular to the direction of travel), the robotic vehicle's ability to roll (such as rotating the robotic vehicle about the horizontal axis parallel to the direction of travel), and the robotic vehicle's ability to yaw (such as rotating the robotic vehicle about a vertical axis).

In some implementations, if the robotic vehicle deviates from the optimal trajectory by more than the distance while traversing the race course, navigation assistance may be provided to the robotic vehicle. In some aspects, the navigation assistance may cause the robotic vehicle to modify its flight path, for example, by instructing the robotic vehicle to change one or more of its velocity, altitude, direction, and pose so that its flight path converges with the optimal trajectory. The navigation assistance may also cause or instruct the robotic vehicle to stop, land, or return home. In some implementations, the navigation assistance may cause or instruct the robotic vehicle to relinquish control of its flight operations to a system controller, which may assume control of the robotic vehicle and thereafter guide the robotic vehicle.

In addition, or in the alternative, different levels of navigation assistance may be provided to a robotic vehicle (or to the pilot). The different levels of navigation assistance may range from a minimal control mode in which the pilot has control over one or two aspects of the robotic vehicle's flight to a full control mode in which the pilot has full control over all aspects of the robotic vehicle's flight. In some aspects, the different levels of navigation assistance may include a number of intermediate control modes in which the pilot has control over different aspects or combinations of aspects of the robotic vehicle's flight.

In some implementations, the optimal trajectory may be modified based on a presence of another robotic vehicle within a distance of the robotic vehicle, and the modified optimal trajectory may be provided to the robotic vehicle to prevent a collision with the other robotic vehicle. In other implementations, the optimal trajectory may be modified based on a crash (or other hazards along the race course), and the modified optimal trajectory may be provided to the robotic vehicle to avoid the crash or other hazards.

As used herein, the term “robotic vehicle” refers to one of various types of vehicles including an onboard computing device configured to provide some autonomous or semi-autonomous capabilities. Examples of robotic vehicles include, but are not limited to, aerial vehicles such as an unmanned aerial vehicle (UAV); ground vehicles (such as an autonomous or semi-autonomous car, truck, or robot) water-based vehicles (such as vehicles configured for operation on the surface of the water or under water), space-based vehicles (such as a spacecraft, space probe, or rocket-powered vehicle), or any combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions from a human operator or other device. In embodiments in which the robotic vehicle is semi-autonomous, the robotic vehicle may include an onboard computing device configured to receive some information or instructions (such as from a human operator using a remote controller device), and to autonomously maneuver and/or navigate the robotic vehicle consistent with the received information or instructions.

In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (such as rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors. For implementations in which the robotic vehicle may be an aerial vehicle, the terms “robotic vehicle,” “UAV,” and “drone” may be used interchangeably herein.

The term Satellite Positioning System (SPS) may refer to any Global Navigation Satellite System (GNSS) capable of providing positioning information to devices on Earth including, for example, the Global Positioning System (GPS) deployed by the United States, the GLObal NAvigation Satellite System (GLONASS) used by the Russian military, and the Galileo satellite system for civilian use in the European Union, as well as terrestrial communication systems that augment satellite-based navigation signals or provide independent navigation information.

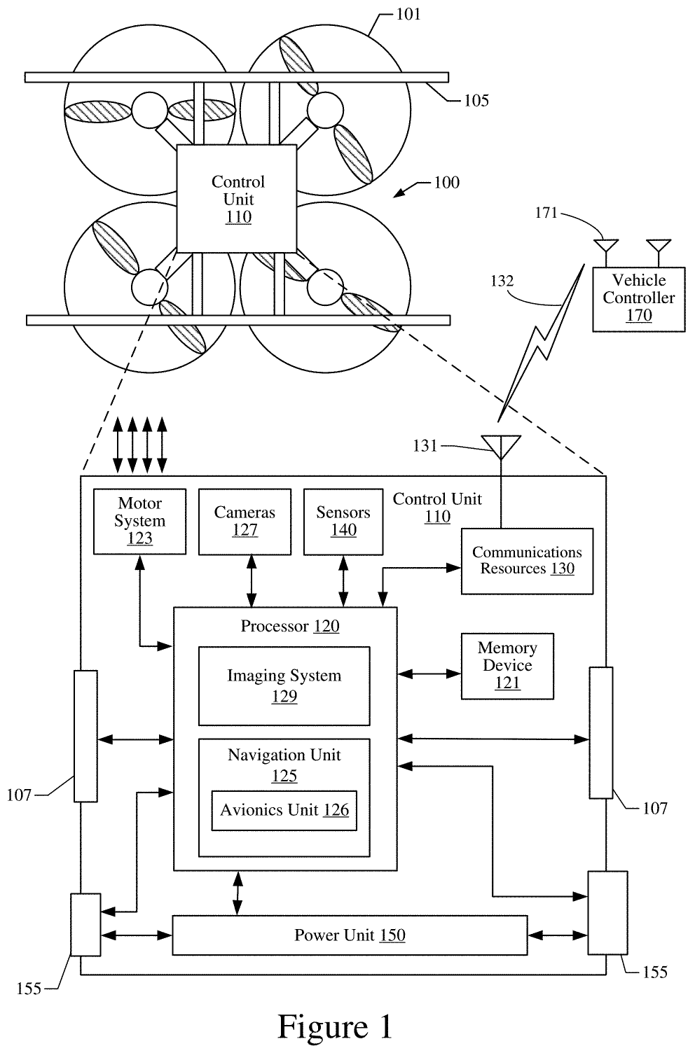

FIG. 1 illustrates an example robotic vehicle 100 suitable for use with various embodiments of the present disclosure. The example robotic vehicle 100 is depicted as a “quad copter” having four horizontally configured rotary lift propellers, or rotors 101 and motors fixed to a frame 105. The frame 105 may support a control unit 110, landing skids and the propulsion motors, the power source (such as a battery), the payload securing unit 107, and other components. Land-based and waterborne robotic vehicles may include compliments similar to those illustrated in FIG. 1.

The robotic vehicle 100 may be provided with a control unit 110. The control unit 110 may include a processor 120, a memory device 121, one or more communication resources 130, one or more sensors 140, and a power unit 150. The memory device 121 may be or include a non-transitory computer-readable storage medium (such as one or more nonvolatile memory elements including, for example, EPROM, EEPROM, Flash memory, a hard drive, and so on) that may store one or more software programs containing instructions or scripts capable of execution by the processor 120.

The processor 120 may be coupled to the memory device 121, the motor system 123, the one or more cameras 127, the one or more communication resources 130, and the one or more sensors 140. The processor 120 may be any one or more suitable processors capable of executing scripts or instructions of one or more software programs stored in a memory (such as the memory device 121). The processor 120 may execute software programs or modules stored in the memory device 121 to control flight and other operations of the robotic vehicle 100, including operations of various embodiments disclosed herein.

In some embodiments, the processor 120 may be coupled to a payload securing unit 107 and a landing unit 155. The processor 120 may be powered from the power unit 150, which may be a battery. The processor 120 may be configured with processor-executable instructions to control the charging of the power unit 150, such as by executing a charging control algorithm using a charge control circuit. In addition, or in the alternative, the power unit 150 may be configured to manage charging. The processor 120 may be coupled to a motor system 123 that is configured to manage the motors that drive the rotors 101. The motor system 123 may include one or more propeller drivers. Each of the propeller drivers includes a motor, a motor shaft, and a propeller. Through control of the individual motors of the rotors 101, the robotic vehicle 100 may be controlled in flight.

In some embodiments, the processor 120 may include (or be coupled to) a navigation unit 125 configured to collect data and determine the present position, speed, altitude, and/or pose of the robotic vehicle 100, to determine the appropriate course towards a destination, and/or to determine the best way to perform a particular function. In some aspects, the navigation unit 125 may include an avionics component 126 configured to provide flight control-related information, such as altitude, pose, airspeed, heading, and other suitable information that may be used for navigation purposes. The avionics component 126 may also provide data indicative of the speed, pose, altitude, and direction of the robotic vehicle 100 for use in navigation calculations. In some embodiments, the information generated by the navigation unit 125, including the avionics component 126, depends on the capabilities and types of the sensors 140 on the robotic vehicle 100.

The control unit 110 may include at least one sensor 140 coupled to the processor 120, which can supply data to the navigation unit 125 and/or the avionics component 126. For example, the sensor(s) 140 may include inertial sensors, such as one or more accelerometers (providing motion sensing readings), one or more gyroscopes (providing rotation sensing readings), one or more magnetometers (providing direction sensing), or any combination thereof. The sensor(s) 140 may also include GPS receivers, barometers, thermometers, audio sensors, motion sensors, etc. Inertial sensors may provide navigational information (such as by dead reckoning), including at least one of the position, orientation, and velocity (e.g., direction and speed of movement) of the robotic vehicle 100. A barometer may provide ambient pressure readings used to approximate elevation level (e.g., absolute elevation level) of the robotic vehicle 100.

In some embodiments, the communication resource(s) 130 may include a GPS receiver, enabling GNSS signals to be provided to the navigation unit 125. A GPS or GNSS receiver may provide three-dimensional coordinate information to the robotic vehicle 100 by processing signals received from three or more GPS or GNSS satellites. GPS and GNSS receivers can provide the robotic vehicle 100 with an accurate position in terms of latitude, longitude, and altitude, and by monitoring changes in position over time, the navigation unit 125 can determine direction of travel and velocity over the ground as well as a rate of change in altitude. In some embodiments, the navigation unit 125 may use an additional or alternate source of positioning signals other than GNSS or GPS. For example, the navigation unit 125 or one or more communication resource(s) 130 may include one or more radio receivers configured to receive navigation beacons or other signals from radio nodes, such as navigation beacons (e.g., very high frequency (VHF) omnidirectional range (VOR) beacons), Wi-Fi access points, cellular network sites, radio stations, etc. In some embodiments, the navigation unit 125 of the processor 120 may be configured to receive information suitable for determining position from the communication resources(s) 130.

In some embodiments, the robotic vehicle 100 may use an alternate source of positioning signals (i.e., other than GNSS, GPS, etc.). Because robotic vehicles often fly at low altitudes (e.g., below 400 feet), the robotic vehicle 100 may scan for local radio signals (e.g., Wi-Fi signals, Bluetooth signals, cellular signals, etc.) associated with transmitters (e.g., beacons, Wi-Fi access points, Bluetooth beacons, small cells (picocells, femtocells, etc.) having known locations, such as beacons or other signal sources within restricted or unrestricted areas near the flight path. In some aspects, the robotic vehicle 100 may determine its relative position (e.g., with respect to one or more wireless transmitting devices) using any suitable wireless network including, but limited to, a Wi-Fi network, a peer-to-peer (P2P) wireless network (such as a Wi-Fi Direct network), a mesh network, a cellular network, or any combination thereof. The Wi-Fi network may be a basis service set (BSS) network, an independent basis service set (IBSS) network, a multiple BSSID set, or other suitable network configuration. In addition, or in the alternative, the wireless network may support a multitude of different wireless communication protocols such as, for example, Wi-Fi protocols, Bluetooth protocols, cellular protocols, WiMAX, and so on).

The navigation unit 125 may use location information associated with the source of the alternate signals together with additional information (e.g., dead reckoning in combination with last trusted GNSS/GPS location, dead reckoning in combination with a position of the robotic vehicle takeoff zone, etc.) for positioning and navigation in some applications. Thus, the robotic vehicle 100 may navigate using a combination of navigation techniques, including dead-reckoning, camera-based recognition of the land features below and around the robotic vehicle 100 (e.g., recognizing a road, landmarks, highway signage, etc.), etc. that may be used instead of or in combination with GNSS/GPS location determination and triangulation or trilateration based on known locations of detected wireless access points.

In some embodiments, the control unit 110 may include a camera 127 and an imaging system 129. The imaging system 129 may be implemented as part of the processor 120, or may be implemented as a separate processor, such as an application specific integrated circuit (ASIC), a field programmable gate array (FPGA), or other logical circuitry. For example, the imaging system 129 may be implemented as a set of executable instructions stored in the memory device 121 that execute on the processor 120 coupled to the camera 127. The camera 127 may include sub-components other than image or video capturing sensors, including auto-focusing circuitry, International Organization for Standardization (ISO) adjustment circuitry, and shutter speed adjustment circuitry, etc.

The control unit 110 may include one or more communication resources 130, which may be coupled to at least one transmit/receive antenna 131 and include one or more transceivers. The transceiver(s) may include any of modulators, de-modulators, encoders, decoders, encryption modules, decryption modules, amplifiers, and filters. The communication resources 130 may be capable of device-to-device and/or cellular communication with other robotic vehicles, wireless communication devices carried by a user (e.g., a smartphone), a robotic vehicle controller, and other devices or electronic systems (e.g., a vehicle electronic system).

The processor 120 and/or the navigation unit 125 may be configured to communicate through the communication resources 130 with a vehicle controller 170 through a wireless connection (e.g., a cellular data network, a Wi-Fi network, a mesh network, and/or any other suitable wireless network) to receive assistance data from the server and to provide robotic vehicle position information and/or other information to the server.

A bi-directional wireless communication link 132 may be established between transmit/receive antenna 131 of the communication resources 130 and the transmit/receive antenna 171 of the vehicle controller 170. In some embodiments, the vehicle controller 170 and robotic vehicle 100 may communicate through an intermediate communication link, such as one or more wireless network nodes or other communication devices. For example, the vehicle controller 170 may be connected to the communication resources 130 of the robotic vehicle 100 through a cellular network base station or cell tower. For another example, the vehicle controller 170 may communicate with the communication resources 130 of the robotic vehicle 100 through a local wireless access node (e.g., a Wi-Fi access point) or through a data connection established in a cellular network. For another example, the vehicle controller 170 and the communication resources 130 of the robotic vehicle 100 may communicate with each other using a suitable peer-to-peer wireless connection (e.g., using a Wi-Fi Direct protocol).

In some embodiments, the communication resources 130 may be configured to switch between a cellular connection and a Wi-Fi connection depending on the position and altitude of the robotic vehicle 100. For example, while in flight at an altitude designated for robotic vehicle traffic, the communication resources 130 may communicate with a cellular infrastructure in order to maintain communications with the vehicle controller 170. For example, the robotic vehicle 100 may be configured to fly at an altitude of about 400 feet or less above the ground, such as may be designated by a government authority (e.g., FAA) for robotic vehicle flight traffic. At this altitude, it may be difficult to establish communication links with the vehicle controller 170 using short-range radio communication links (e.g., Wi-Fi). Therefore, communications with the vehicle controller 170 may be established using cellular telephone networks while the robotic vehicle 100 is at flight altitude. Communications with the vehicle controller 170 may transition to a short-range communication link (e.g., Wi-Fi or Bluetooth) when the robotic vehicle 100 moves closer to a wireless access point.

While the various components of the control unit 110 are illustrated in FIG. 1 as separate components, some or all of the components (e.g., the processor 120, the motor system 123, the communication resource(s) 130, and other units) may be integrated together in a single device or unit, such as a system-on-chip. The robotic vehicle 100 and the control unit 110 may also include other components not illustrated in FIG. 1.

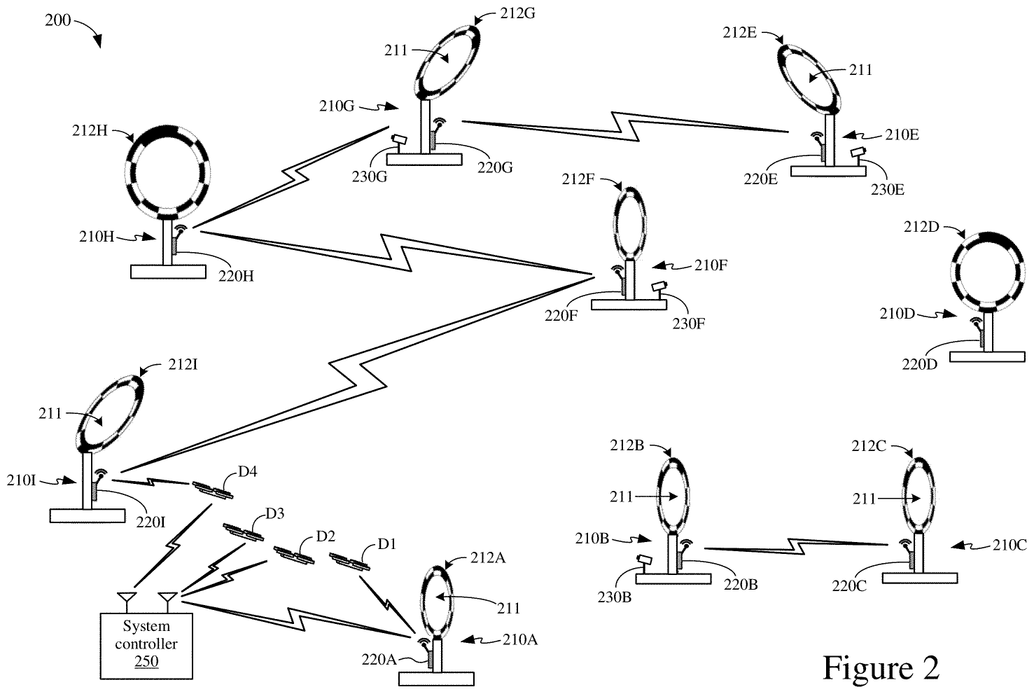

FIG. 2 is a diagram of an example race course 200 that may be suitable for use with aspects of the present disclosure. The race course 200 may be defined by a plurality of gates 210A-210I and used for races between a number of robotic vehicles such as, for example, the four UAVs D1-D4 shown in FIG. 2. In other implementations, the race course 200 may be used for timing a single UAV (or other suitable robotic vehicle). The plurality of gates 210A-210I may be positioned in various locations in an area suitable for races between UAVs (or alternatively, for a time-based race involving only one UAV). The race course 200 may be located indoors, outdoors, or a combination thereof. The UAVs D1-D4 depicted in FIG. 2 may be any suitable robotic vehicle or drone such as, for example, the robotic vehicle 100 of FIG. 1. Although depicted in FIG. 2 as including nine gates 210A-210I, the race course 200 may be defined by (or may include) any suitable number of gates. Similarly, although only four UAVs D1-D4 are shown in FIG. 2 for simplicity, any suitable number of UAVs may participate in races using the race course 200.

With reference to FIGS. 1-2, the gates 210A-210I may include respective fiducial markers 212A-212I. Each of the fiducial markers 212A-212I may encode various information, such as (but not limited to) location information, ordering information, and pose information of a corresponding one of the gates 210A-210I. In some implementations, each of the fiducial markers 212A-212I may include or display a unique pattern that encodes the various information, such as (but not limited to) location information, ordering information, and pose information for the corresponding one of the gates 210A-210I. In some aspects, the fiducial markers 212A-212I may be removable from the gates 210A-210I. In other aspects, the fiducial markers 212A-212I may be integrated within the gates 210A-210I, for example, to form fiducial gates.

The unique patterns may be any suitable pattern that can be detected and decoded by cameras (such the cameras 127) provided on the UAVs D1-D4, for example, so that the UAVs D1-D4 can determine the location, ordering, and pose information of the gates 210A-210I as the UAVs D1-D4 traverse the race course 200. In some aspects, the unique patterns may be AprilTags, QR codes, or any other suitable pattern that can be detected by cameras provided on the UAVs D1-D4 and decoded by image recognition circuits or software to determine the locations, orderings, and poses of the gates 210A-210I. In some implementations, one or more of the gates 210A-210I that define the race course 200 may not include fiducial markers.

The locations, orderings, and poses of the gates 210A-210I may be stored in a suitable memory within each of the UAVs D1-D4. In some aspects, each of the UAVs D1-D4 may include a look-up table (LUT) that can store mappings between the unique patterns and the gate information. In some aspects, mappings between the unique patterns and the gate information may be determined by the UAVs D1-D4. In other aspects, mappings between the unique patterns and the gate information may be provided to the UAVs D1-D4 by a system controller 250, which is described in more detail below.

The location information may indicate the location or position of each of the gates 210A-210I. A UAV (e.g., UAVs D1-D4) may use its camera to identify a gate's fiducial marker, and the UAV may use image recognition techniques to decode the location of the gate. The UAV may determine its position and speed using the navigation unit 125 and may derive its position relative to the gate based on the determined location of the gate and its determined position.

The ordering information may indicate an order through which the UAVs D1-D4 are to traverse the gates 210A-210I during a race. For example, the first gate 210A may have an ordering value equal to 1, the second gate 210B may have an ordering value equal to 2, the third gate 210C may have an ordering value equal to 3, and so on, where the last gate 210I may have an ordering value equal to 9. Thus, during an example race, the UAVs D1-D4 may sequentially fly through all of the gates 210A-210I in the specified order to complete one lap around the race course 200. In some implementations, the race course 200 may include a lap counter (not shown for simplicity) configured to count the number of laps successfully completed by each of the UAVs D1-D4. In some implementations, the order through which the UAVs D1-D4 are to traverse the gates 210A-210I may be changed or modified between races and/or during a race, and therefore the ordering information may also change between races and/or during a race. For example, in a subsequent race, the first gate 210A may have an ordering value equal to 1, the sixth gate 210F may have an ordering value equal to 2, the second gate 210C may have an ordering value equal to 3, and so on. In other implementations, a course may traverse through a number of selected gates 210A-210I multiple times (e.g., in a figure-8 or similar pattern), and thus one or more of the gates 210A-210I may be assigned multiple ordering values. For example, in a course that traverses through gates 210A-210F sequentially and then again traverses through the third gate 210C, the third gate 210C may have ordering values equal to 3 and to 7 (e.g., to indicate that UAVs D1-D4 are to navigate through the first six gates 210A-210F in sequential order, and then navigate through the third gate 210C).

The pose information may indicate the pose of each of the gates 210A-210I. A UAV (e.g., UAVs D1-D4) may use its camera to determine the relative pose between the UAV and the gate, and then the UAV may derive its actual pose based on known pose of the gate and the relative pose between the gate and the UAV. For example, as a UAV traverses the race course 200, the UAV's camera may identify a gate's fiducial marker, and the UAV may use image recognition techniques to decode the pose of the gate. The UAV may derive its actual pose based on the pose of the gate and the determined relative pose, for example, using the navigation unit 125.

In some implementations, each of the gates 210A-210I may be a circular gate having a circular opening 211 through which the UAVs D1-D4 may traverse during a race. The openings 211 provided within the gates 210A-210I may define a flight path around the race course 200. In some aspects, each of the fiducial markers 212A-212I may be presented around a perimeter of the opening 211 in a corresponding one of the gates 210A-210I, for example, so that cameras mounted on the UAVs can easily identify the fiducial markers 212A-212I without the need to pan or re-orient the cameras for each of the gates 210A-210I. In other implementations, one or more of the gates 210A-210I may be of another suitable shape (e.g., an ellipse, a rectangle, or a triangle), and/or their respective openings 211 may be of another suitable shape. In other aspects, one or more of the gates 210A-210I may be of different sizes and shapes, and/or their respective openings 211 may be of different sizes and shapes.

More specifically, when a UAV (e.g., UAVs D1-D4) approaches a gate (e.g., a selected one of the gates 210A-210I), the pilot may align the UAV with a center portion of the opening 211 formed in the gate. Because the fiducial marker (e.g., a corresponding one of respective fiducial markers 212A-212I) is presented around the perimeter of the opening 211, the UAV's camera may be aligned with (and oriented to capture) the fiducial marker simply by remaining in a forward-facing direction, thereby eliminating (or at least substantially reducing) the need to pan or re-orient the UAV's camera to locate the fiducial markers 212A-212I as the UAV traverses the race course 200. In this manner, aspects of the present disclosure may allow a pilot to spend more time piloting the UAV and less time trying to locate fiducial markers provided throughout the race course. This may allow less-experienced pilots (such as amateur pilots) to participate in races that would otherwise be too difficult, and may allow more experienced pilots (such as professional pilots) to fly UAVs at greater speeds.

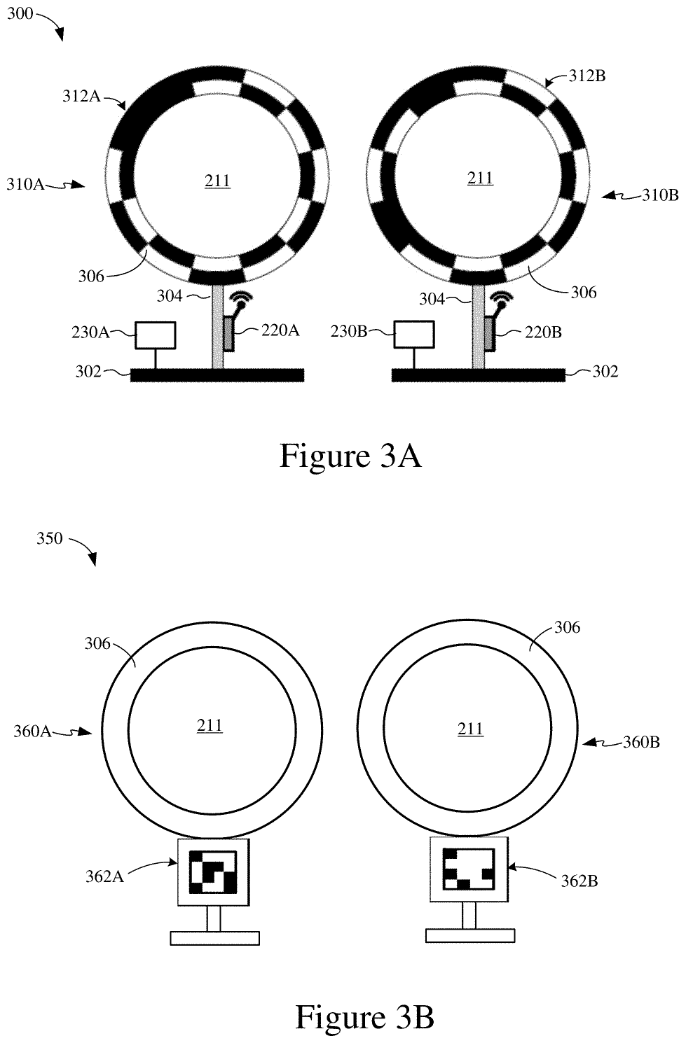

FIG. 3A shows an illustration 300 depicting two gates 310A and 310B (either of which, in some aspects, may be examples of the gates 210A-210L in FIG. 2) in accordance with some embodiments. With reference to FIGS. 1-3A, the first gate 310A includes a base 302 upon which a stand 304 is mounted to support a circular gate portion 306. The circular gate portion 306 includes an opening 211 through which UAVs may traverse during a race. A first fiducial marker 312A is displayed around the circular gate portion 306 of the first gate 310A, for example, so that the first fiducial marker 312A surrounds the perimeter of the opening 211. The first fiducial marker 312A includes a unique pattern that may encode the location, the ordering, and the pose of the first gate 310A. The second gate 310B is similar to the first gate 310A, except that the second gate 310B displays a second fiducial marker 312B including a unique pattern that may encode the location, the ordering, and the pose of the second gate 310B.

The first and second gates 310A and 310B may be of any suitable shape (such as a square gate, a hexagonal gate, a triangular gate, or an elliptical gate) that can include an opening through which UAVs may traverse during a race.

As discussed, presenting the fiducial markers 312A and 312B around the perimeters of the openings 211 of the gates 310A and 310B may allow cameras mounted on UAVs to easily identify the fiducial markers 312A and 312B and decode the gate information conveyed by their respective unique patterns without panning or re-orienting the cameras. Moreover, by using the entire surface area of the circular gate portions 306 to display the fiducial markers 312A and 312B, a UAV (e.g., UAVs D1-D4) may be able to locate and capture the fiducial markers 312A and 312B from greater distances than would be possible if the fiducial markers 312A and 312B occupied a smaller portion of the gates.

FIG. 3B shows an illustration 350 depicting two gates 360A and 360B (either of which, in some aspects, may be examples of the gates 210A-210L in FIG. 2) in accordance with some embodiments. With reference to FIGS. 1-3B, the gates 360A and 360B each include a circular gate portion 306 having an opening 211 through which UAVs may traverse during a race. However, unlike the gates 310A and 310B, fiducial markers 362A and 362B are displayed on placards mounted below the openings 211 of the gates 360A and 360B. As a result, when a UAV (e.g., UAVs D1-D4) approaches the gates 360A and 360B, the UAV's camera may need to be orientated in a downward direction to locate their respective fiducial markers 312A and 312B.

According to various aspects, the system controller 250 may be configured to manage various operations related to the race course 200, the gates 210A-210I, the UAVs D1-D4, and/or the pilots. In some implementations, the system controller 250 may send control signals to the gates 210A-210I, and may receive gate information (such as gate locations, gate orderings, and gate poses) from one or more of the gates 210A-210I. In some aspects, the system controller 250 may generate a digital map of the race course 200 based at least in part on gate information received from the gates 210A-210I. In addition, or in the alternative, the system controller 250 may receive race status information from one or more of the gates 210A-210I. The race status information may indicate the positions, poses, and timing information of the UAVs, and/or may indicate occurrences and locations of crashes or other hazards in the race course 200.

The system controller 250 may transmit the race status information to the UAVs D1-D4, for example, to inform the UAVs D1-D4 of their positions relative to each other and as to the occurrence of crashes or other hazards in the race course 200. The system controller 250 may also transmit commands to the UAVs D1-D4. The commands may instruct one or more of the UAVs to perform certain actions (such as slowing down, stopping, or landing), may instruct one or more of the UAVs to relinquish control of flight operations to the system controller 250, and/or may instruct one or more of the UAVs to adjust or modify certain capabilities.

In some implementations, the system controller 250 may receive data from the UAVs D1-D4. For example, the system controller 250 may receive locations, velocities, flight paths, operating conditions, streaming video, and other information from the UAVs D1-D4. In some aspects, the system controller 250 may receive one or more operating parameters of the UAVs D1-D4, and may selectively transmit commands (or other control signals) to the UAVs D1-D4 based on the one or more operating parameters received from the UAVs D1-D4. For example, if a selected one of the UAVs D1-D4 crashes, the system controller 250 may transmit commands to the selected UAV that allows the system controller 250 to assume control of the selected UAV.

The system controller 250 may provide a communication interface between one or more devices associated with the race course 200 (e.g., the UAVs D1-D4, the gates 210A-210I, devices associated with the pilots, devices associated with spectators of the race, and so on) and one or more external networks (e.g., the Internet, a cellular backhaul connection, a Wi-Fi backhaul connection, a POTS network, a satellite positioning system, and so on).

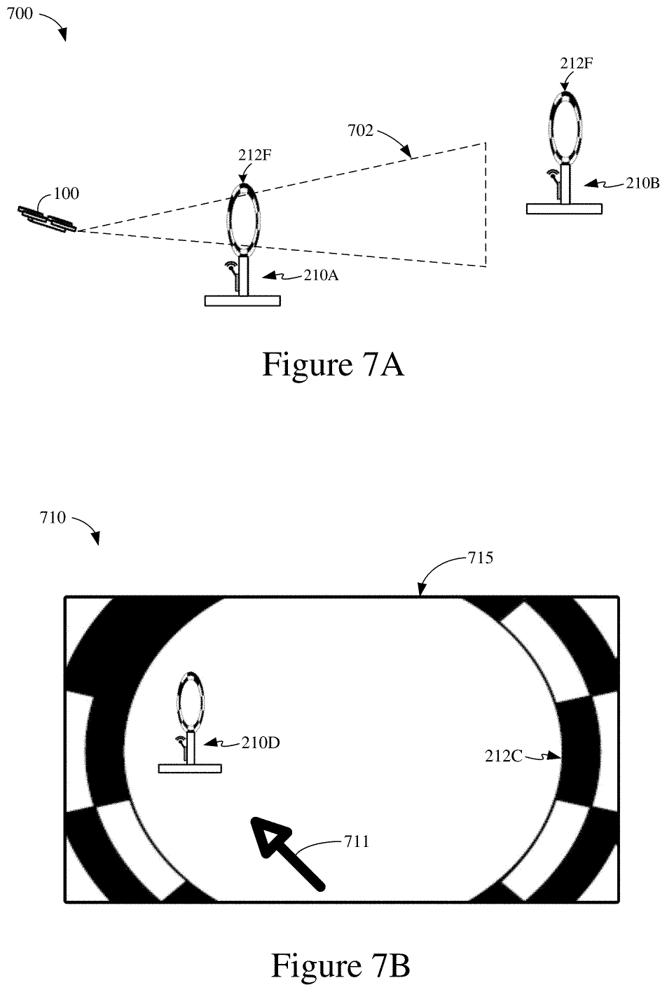

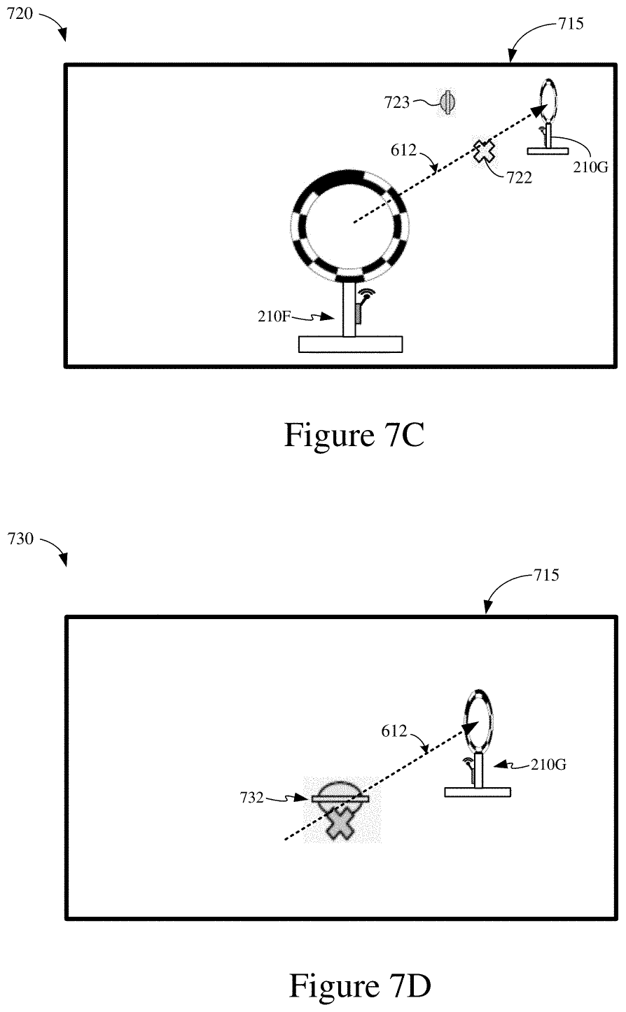

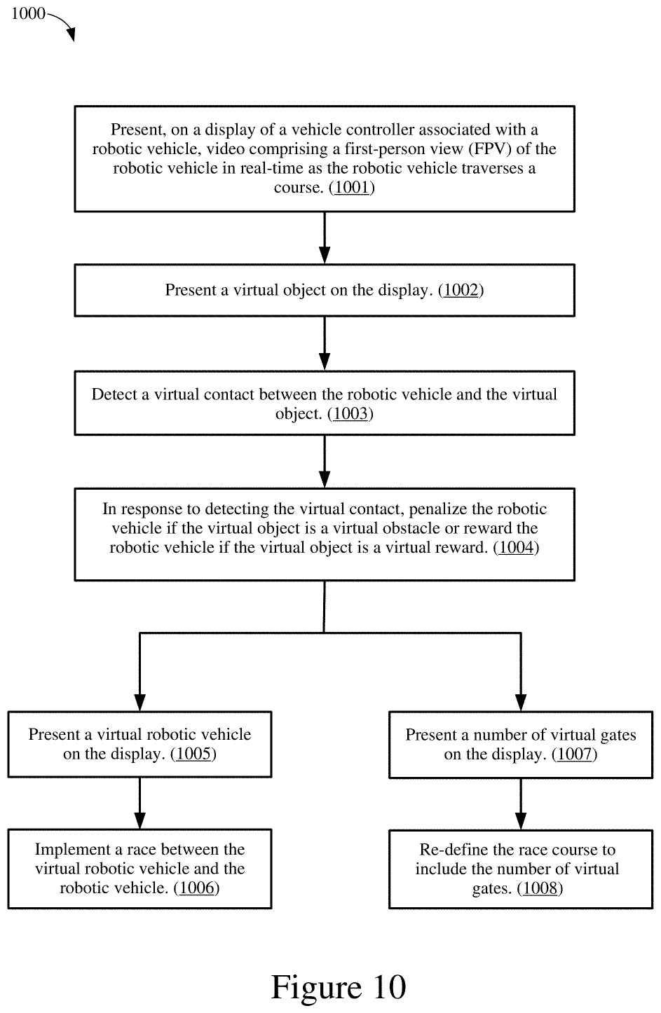

In some implementations, the system controller 250 may provide navigation assistance to one or more UAVs participating in a race through the race course 200. In some aspects, the system controller 250 may provide different levels of navigation assistance to different UAVs participating in a race, for example, based on the capabilities of the UAVs, based on the skill levels of the pilots, based on preferences of the pilots, or any combination thereof. In other aspects, the system controller 250 may select one of a number of different levels of navigation assistance to provide to the UAVs based on the type of race. For one example, in a basic “slot car” race mode, the system controller 250 may allow the pilots to control only the speed of their respective UAVs, with all other aspects of the UAVs' flights controlled by the system controller 250. For another example, in a “guardian” race mode, the system controller 250 may allow the pilots to control all aspects of their respective UAVs, and the system controller 250 may provide navigation assistance only to prevent collisions. For another example, in an “intermediate” race mode, the system controller 250 may allow the pilots to control some aspects (such as left/right directions and up/down directions) of the UAVs, but maintain control of other navigational aspects of the UAVs. In addition, or in the alternative, the system controller 250 may augment races between UAVs with a number of virtual reality features (e.g., as discussed with respect to FIGS. 7A-7D and 10).

In some implementations, the gates 210A-210I may include respective wireless transceivers 220A-220I that allow the gates 210A-210I to transmit and receive wireless signals. The wireless transceivers 220A-220I can be configured to form a wireless network that may facilitate wireless communications between the gates 210A-210I, wireless communications between the system controller 250 and each of the UAVs participating in the race, wireless communications between each of the UAVs and an associated pilot, wireless communications between the UAVs (such as peer-to-peer communications), wireless communications with a number of spectators, or any combination thereof. The wireless network may be any suitable wireless network including, for example, a Wi-Fi network (such as a BSS wireless network or an IBSS wireless network), a peer-to-peer (P2P) wireless network (such as a Wi-Fi Direct network), a mesh network, a cellular network, or any combination thereof. In some aspects, the wireless network may support a multitude of different wireless communication protocols such as, for example, Wi-Fi protocols, Bluetooth protocols, cellular protocols, WiMAX, and so on).

In some implementations, the gates 210A-210I may transmit their location, ordering, and pose information to each other, to one or more of the UAVs D1-D4, to their controllers, to the system controller 250, to devices associated with spectators of the race, to other wireless devices, and so on. In some aspects, each of the gates 210A-210I may broadcast its location, ordering, and pose information using a suitable broadcast frame or multi-cast frame. In this manner, the gates 210A-210I and/or the system controller 250 may provide real-time updates of the positions, velocities, orderings, and poses of the UAVs D1-D4 to any suitable wireless device that can join the wireless network or that can receive wireless signals from the gates 210A-210I and/or from the system controller 250.

In some implementations, one or more of the gates 210A-210I may include respective video cameras 230A-230I (not all video cameras 230A-230I shown for simplicity). The video cameras 230A-230I may capture photos or videos during races, and the wireless transceivers 220A-220I may transmit the captured photos or videos to the system controller 250, to the UAVs participating in the race, and/or to other gates. In some implementations, the captured photos or videos may be analyzed to determine the flight information (such as positions, poses, and orderings) of the UAVs and/or to detect an occurrence of crashes or other hazards in the vicinities of respective gates 210A-210I.

Although not shown for simplicity, in some implementations, one or more of the gates 210A-210I may include a beam-breaking mechanism that can determine the times at which each of the UAVs D1-D4 traverses through a corresponding one of the gates 210A-210I. Timing information provided by the beam-breaking mechanisms may be used to determine lap times or intervals for each of the UAVs D1-D4, and may be combined with ordering information of the gates 210A-210I to determine sub-lap times for each of the UAVs D1-D4 participating in the race.

In some implementations, each of the UAVs D1-D4 may periodically broadcast wireless signals from which the other UAVs may determine proximity information. Each of the UAVs D1-D4 may use the proximity information to determine a presence of other nearby UAVs. In some aspects, the proximity information may indicate that another UAV is rapidly approaching, that another UAV is about to perform a cut-off maneuver, that a collision is likely, and so on. In some implementations, the UAVs D1-D4 may use short-range, low-energy wireless signals (such as Bluetooth Low Energy signals) to determine UAV proximity information.

Each of the UAVs D1-D4 may be controlled or maneuvered by a pilot using a suitable wireless communication device (not shown for simplicity). In some implementations, a pilot may use the vehicle controller 170 to fly a corresponding UAV around the race course 200. In other implementations, the pilots may use other suitable vehicle controllers to control flight operations of the UAVs D1-D4.

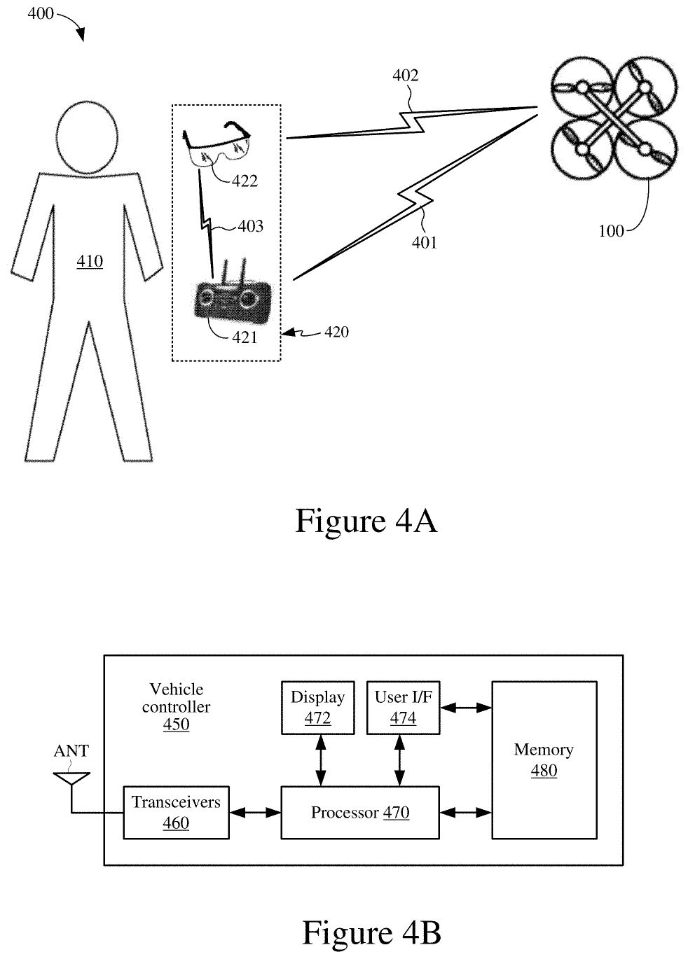

FIG. 4A shows an illustration 400 depicting a pilot 410 using a vehicle controller 420 to control various flight operations of a robotic vehicle (e.g., the robotic vehicle 100 of FIG. 1 or the UAVs D1-D4 of FIG. 2). In some implementations, the vehicle controller 420 may be one example of the vehicle controller 170. With reference to FIGS. 1-4A, the vehicle controller 420 may include a wireless controller 421 and a headset 422. The wireless controller 421 may allow the pilot 410 to control various operations of the robotic vehicle 100, and the headset 422 may provide the pilot 410 with a first-person view (FPV) of the robotic vehicle 100, for example, so that the pilot 410 may experience what the robotic vehicle 100 “sees” in real-time. In some implementations, the wireless controller 421 and the headset 422 may be separate components. In other implementations, the functionalities of the headset 422 (such as the display) may be incorporated into the wireless controller 421.

Wireless signals may be exchanged between the robotic vehicle 100 and the wireless controller 421 via a first wireless link 401, wireless signals may be exchanged between the robotic vehicle 100 and the headset 422 via a second wireless link 402, and wireless signals may be exchanged between the wireless controller 421 and the headset 422 via a third wireless link 403. In some implementations, the wireless links 401-403 may be peer-to-peer wireless connections. In other implementations, the wireless links 401-403 may be facilitated by the wireless network formed by the wireless transceivers 220A-220I. In addition, or in the alternative, the wireless controller 421, the headset 422, and the robotic vehicle 100 may communicate with each other using cellular signals transmitted via a suitable cellular network.

The wireless controller 421 may be any suitable device that can wirelessly transmit commands to the robotic vehicle 100, receive wireless data from the robotic vehicle 100, and exchange data and/or commands with the headset 422. In some implementations, the wireless controller 421 may transmit flight commands and non-flight commands to the robotic vehicle 100. The flight commands may include, for example, directional commands (such as commands to turn right, to turn left, to ascend, to descend, to rotate (such as to pitch, roll, and/or yaw), to strafe, to alter pose, and so on), speed commands (such as commands to increase or decrease a velocity of the robotic vehicle 100), lift-off and land commands, stop commands, return-to-home commands, and other suitable commands. The non-flight commands may include, for example, commands to turn on or off one or more lights of the robotic vehicle 100, commands to start or stop capturing video, commands to start or stop transmitting streaming video, commands to move, pan, or zoom the camera, and other suitable commands to set or adjust image capture settings of the cameras.

The wireless controller 421 may receive streaming video captured from one or more cameras of the robotic vehicle 100, and may present the streaming video on a display, for example, to provide a first-person view (FPV) of the robotic vehicle 100 to the pilot 410. The wireless controller 421 may also receive flight data (such as speed, direction, pose, altitude, acceleration, and remaining battery life information) from the robotic vehicle 100.

The headset 422 may be any suitable device that can display streaming video transmitted from the robotic vehicle 100. In some implementations, the streaming video may be transmitted directly from the robotic vehicle 100 to the headset 422. In other implementations, the streaming video may be transmitted from the robotic vehicle 100 to the headset 422 via the wireless controller 421. The headset 422 may include any suitable display capable of presenting streaming video comprising a first-person view of the robotic vehicle 100 to the pilot in real-time. In some aspects, the headset 422 may be virtual reality (VR) glasses or augmented reality (AR) glasses. In other aspects, the headset 422 may be a display screen such as, for example a smartphone, a tablet computer, or a laptop. In addition, or in the alternative, the wireless controller 421 may include a display capable of presenting streaming video comprising a first-person view of the robotic vehicle 100 to the pilot in real-time.

FIG. 4B is a block diagram of a vehicle controller 450 suitable for use in various embodiments disclosed herein. The vehicle controller 450 may be an example of the vehicle controller 170 of FIG. 1 and/or the vehicle controller 420 of FIG. 4A. With reference to FIGS. 1-4B, the vehicle controller 450 may include one or more antennas (ANT), one or more transceivers 460, a processor 470, a display 472, a user interface 474, and a memory 480. In some aspects, the transceivers 460 may be used to transmit wireless signals to the headset 422 and the robotic vehicle 100, and may be used to receive wireless signals from the headset 422 and the robotic vehicle 100. The display 472 may be any suitable display or screen capable of presenting streaming video transmitted from the robotic vehicle 100 for viewing by the pilot. In other implementations, the vehicle controller 450 may not include the display 472.

The user interface 474 may be any suitable mechanism that allows the pilot 410 to control flight operations and non-flight operations of the robotic vehicle 100. For example, the user interface 474 may include a number of knobs, joysticks, rollers, switches, buttons, touch pads or screens, and/or any other suitable components that allow the pilot 410 to send commands to the robotic vehicle 100.

In some aspects, the system controller 250 may transmit data to the vehicle controller 450 for augmenting races between robotic vehicles with one or more virtual reality features. For example, in some implementations, the vehicle controller 450 may augment the streaming video received from a robotic vehicle (e.g., robotic vehicle 100 or one of UAVs D1-D4) with virtual features or objects constructed by the system controller 250. In some aspects, the vehicle controller 450 may overlay the virtual features or objects onto the streaming video received from a robotic vehicle 100 to generate an augmented streaming video, and may present the augmented streaming video on the display 472 for viewing by a pilot (e.g., 410). In this manner, aspects of the present disclosure may introduce virtual reality features into a drone race (e.g., as described with respect to FIGS. 7A-7D and FIG. 10).

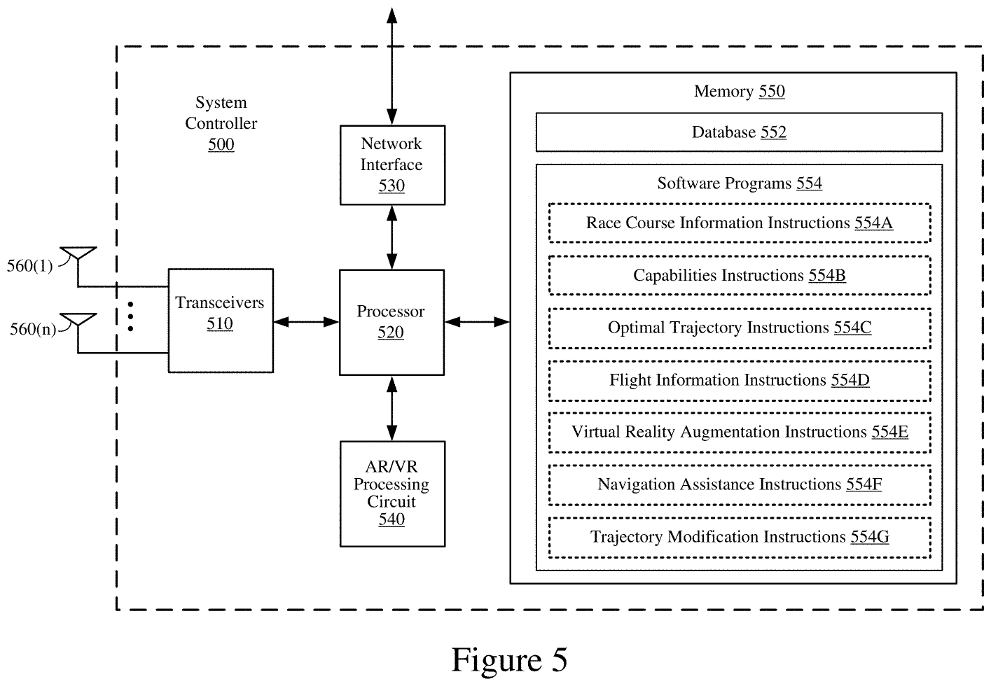

FIG. 5 shows a block diagram of an example system controller 500. The system controller 500 may be one implementation of the system controller 250 of FIG. 2 or another system controller. With reference to FIGS. 1-5, the system controller 500 may include at least a number of transceivers 510, a processor 520, a network interface 530, a VR/AR processing circuit 540, a memory 550, and a number of antennas 560(1)-560(n). The transceivers 510 may be coupled to antennas 560(1)-560(n), either directly or through an antenna selection circuit (not shown for simplicity). The transceivers 510 may be used to transmit signals to and receive signals from other wireless devices.

The processor 520 may be one or more suitable processors capable of executing scripts or instructions of one or more software programs stored in the system controller 500 (such as within the memory 550). More specifically, the processor 520 may be or include one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. In some implementations, the processor 520 may be general-purpose processor such as a microprocessor. In some other implementations, the processor 520 may be implemented as a combination of computing devices including, for example, a combination of a DSP and a microprocessor, a plurality of microprocessors, one or more microprocessors in conjunction with a DSP core, or any other suitable configuration.

The network interface 530 is coupled to the processor 520, and may facilitate communications with one or more external networks or devices including, for example, a local area network (LAN), a wide area network (WAN), a metropolitan area network (MAN), the Internet, a public switched telephone network (PSTN), and the like. In some implementations, the network interface 530 may provide a backhaul connection for wireless networks formed by transceivers provided on or associated with the gates 210A-210I.

The VR/AR processing circuit 540 is coupled to the processor 520, and may be used to augment races between robotic vehicles with virtual reality features. In some implementations, the VR/AR processing circuit 540 may define and manipulate virtual objects (such as virtual obstacles, virtual rewards, virtual robotic vehicles, and virtual gates) to be displayed within (or overlaid onto) streaming video presented on a display for viewing by a robotic vehicle's pilot (e.g., 410). The VR/AR processing circuit 540 may also manage interactions between “real” robotic vehicle (such as the robotic vehicle 100 or the UAVs D1-D4) and virtual objects presented within the first-person view of a robotic vehicle. In some aspects, the VR/AR processing circuit 540 may detect virtual contact between the robotic vehicles and the virtual objects, and may generate one or more commands to be transmitted to the robotic vehicles and/or their vehicle controllers 450 based on the detected virtual contacts.

The memory 550 may include a database 552 to store information associated with or pertaining to the race course 200, the gates 210A-210I, the robotic vehicles, the pilots 410, the wireless network formed by the gates 210A-210I, and virtual objects. For example, the database 552 may store gate information such as the locations, orderings, and poses of the gates 210A-210I and may store race hazards such as the occurrence and locations of crashes or other hazards. The database 552 may store robotic vehicle information such as (but not limited to) the identities, capabilities, and flight histories of robotic vehicles. The database 552 may store pilot information such as (but not limited to) the skill levels, preferences, risk tolerances, race histories, and other suitable information about a number of pilots. The database 552 may store wireless network information such as channel information, bandwidth information, status information, and other suitable parameters of the wireless network. The database 552 may store virtual reality information such as (but not limited to) parameters for defining and manipulating virtual obstacles, virtual rewards, virtual gates, virtual robotic vehicles, and other suitable virtual reality features.

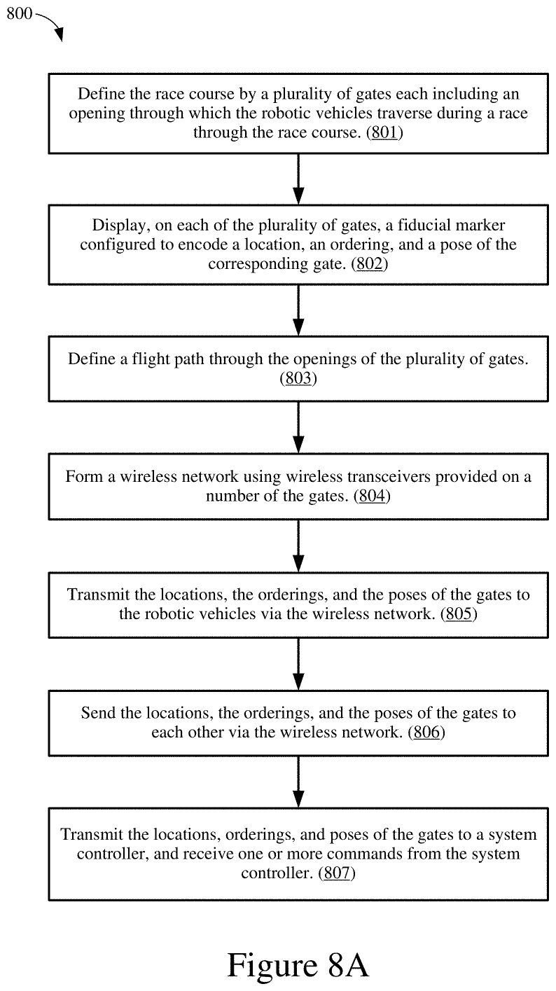

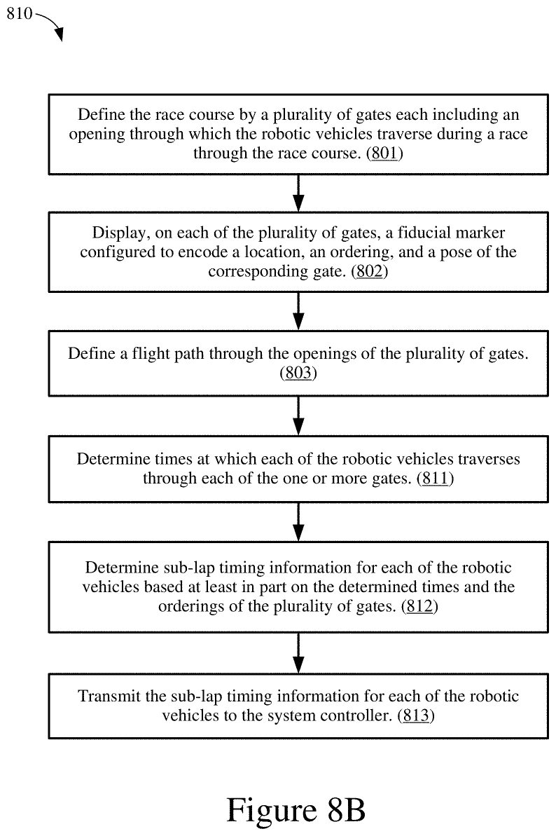

The memory 550 also may include a non-transitory computer-readable medium (such as one or more nonvolatile memory elements, such as EPROM, EEPROM, Flash memory, a hard drive, and so on) to store a number of software programs 554. In some implementations, the software programs 554 may include (but is not limited to) at least the following sets of instructions, scripts, commands, or executable code:
race course information instructions 554A to determine gate information (such as the locations, orderings, and poses of the gates 210A-210I) and race hazards (such as the occurrence and locations of crashes or other hazards) of the race course 200 (e.g., as described for one or more operations of FIGS. 8A-8B, 9A-9D, and 10);
capabilities instructions 554B to determine the identities and capabilities of robotic vehicles participating in the race and/or to selectively modify one or more capabilities of the robotic vehicles (e.g., as described for one or more operations of FIGS. 8A-8B, 9A-9D, and 10);
optimal trajectory instructions 554C to generate or determine an optimal trajectory and/or a virtual tunnel through the race course 200 (e.g., as described for one or more operations of FIGS. 8A-8B, 9A-9D, and 10);
flight information instructions 554D to determine the flight paths of robotic vehicles participating in the race, to monitor or determine the positions and lap times of the robotic vehicles, and/or to determine whether any of the robotic vehicles has deviated from the optimal trajectory by more than a distance (e.g., as described for one or more operations of FIGS. 8A-8B, 9A-9D, and 10);
virtual reality augmentation instructions 554E to create and present a number of virtual objects on a display for viewing by a robotic vehicle's pilot, to detect virtual contact between the robotic vehicle and the virtual objects, to manipulate the virtual objects, and to reward or penalize the robotic vehicles based at least in part on the detected virtual contact (e.g., as described for one or more operations of FIGS. 8A-8B, 9A-9D, and 10);
navigation assistance instructions 554F to provide navigation assistance to one or more robotic vehicles (e.g., as described for one or more operations of FIGS. 8A-8B, 9A-9D, and 10); and
trajectory modification instructions 554G to selectively modify the optimal trajectory (e.g., as described for one or more operations of FIGS. 8A-8B, 9A-9D, and 10).
   The software programs include instructions or scripts that, when executed by the processor 520, cause the system controller 500 to perform the corresponding functions. The non-transitory computer-readable medium of the memory 550 thus includes instructions for performing all or a portion of the operations (e.g., of FIGS. 8A-8B, 9A-9D, and 10).

The processor 520 may execute the race course information instructions 554A to determine gate information (such as the locations, orderings, and poses of the gates) and race hazards (such as the occurrence and locations of crashes). In some implementations, execution of the race course information instructions 554A may cause the system controller 500 transmit a request for one or more gates (such as the gates 210A-210I) to send gate information to the system controller 500 and/or for one or more of the gates to monitor corresponding portions of the race course 200 for crashes and other hazards. In some implementations, cameras (such as the video cameras 230A-230I) provided on or associated with a number of gates may be used to detect the occurrence of crashes and other hazards. In some aspects, the gates may analyze video captured by their associated cameras to determine the occurrence of crashes and other hazards, and may transmit status information indicating the occurrences and locations of the detected crashes to the system controller 500. In other aspects, the gates may transmit video captured by their associated cameras to the system controller 500, which may detect the occurrences and locations of crashes based on the received video.

The processor 520 may execute the capabilities instructions 554B to determine the identities and capabilities of the robotic vehicles participating in the race and/or to selectively modify one or more capabilities of the robotic vehicles based on race hazards, pilot preferences, virtual contact with one or more virtual objects, and other suitable conditions or parameters. The capabilities of a robotic vehicle may include one or more of a remaining battery life of the robotic vehicle, a maximum velocity of the robotic vehicle, a maximum altitude of the robotic vehicle, a maximum acceleration of the robotic vehicle, pose information of the robotic vehicle, turning characteristics of the robotic vehicle, and so on.

The processor 520 may execute the optimal trajectory instructions 554C to generate or determine an optimal trajectory and/or a virtual tunnel through the race course 200. The optimal trajectory may include position information, velocity information, acceleration information, altitude information, pose information, and turning characteristics (such as pitch, roll, and yaw) for a number of robotic vehicles participating in a race through the race course 200. In some implementations, the optimal trajectory may be defined as a function of time, for example, so that the actual flight path of the robotic vehicle may be compared with the optimal trajectory at selected instances of time, during selected periods of time, or continuously, and so that navigation assistance may be determined for (and provided to) the robotic vehicle in real-time.

In some implementations, the processor 520 may execute the optimal trajectory instructions 554C to generate or determine an optimal trajectory and/or a virtual tunnel for each robotic vehicle participating in the race, for example, so that each robotic vehicle may be provided with an optimal trajectory and/or virtual tunnel that is based at least in part on the specific capabilities of the robotic vehicle and/or on the specific preferences of the robotic vehicle's pilot.

The processor 520 may execute the flight information instructions 554D to determine the flight paths of robotic vehicles participating in the race, to monitor or determine the positions and lap times of the robotic vehicles, and/or to determine whether any of the robotic vehicles has deviated from the optimal trajectory by more than a distance. In some aspects, deviations between the robotic vehicles' actual flight path and the optimal trajectory may be determined, at least in part, as a function of both time and distance. The flight paths of the robotic vehicles may be based on flight information (such as positions, velocities, altitudes, and poses) of the robotic vehicles. The flight information may be provided to the system controller 500 by the robotic vehicle, by the gates, or both. The positions and lap times of the robotic vehicles may be based at least in part on the determined gate information, on flight information of the robotic vehicles, on streaming video transmitted by the robotic vehicles, or any combination thereof.

The processor 520 may execute the virtual reality augmentation instructions 554E to create and present a number of virtual objects on a display for viewing by a robotic vehicle's pilot (e.g., 410), to detect virtual contact between the robotic vehicle and the virtual objects, to manipulate the virtual objects, and to reward or penalize the robotic vehicles based at least in part on the detected virtual contact.

The processor 520 may execute the navigation assistance instructions 554F to provide navigation assistance to one or more selected robotic vehicles participating in the race. In some implementations, execution of the navigation assistance instructions 554E may be triggered by a determination that a selected robotic vehicle has deviated from the optimal trajectory by more than the distance. The navigation assistance may include commands that change a speed, altitude, pose, and/or direction of the selected robotic vehicle, may include commands that cause the selected robotic vehicle to stop, land, or return home, may include commands that restrict one or more flight parameters of the selected robotic vehicle, and/or may include commands that allow the system controller 500 to assume control of the selected robotic vehicle.

In some aspects, the system controller 500 may provide different levels of navigation assistance to different robotic vehicles participating in a race, for example, based on the capabilities of the robotic vehicles, based on the skill levels of the pilots, based on preferences of the pilots, or any combination thereof. In other aspects, the system controller 500 may select one of a number of different levels of navigation assistance to provide to the robotic vehicles based on the type of race. For one example, in a basic “slot car” race mode, the system controller 500 may allow the pilots to control only the speed of their respective robotic vehicles, with all other aspects of the robotic vehicles' flights controlled by the system controller 500. For another example, in a “guardian” race mode, the system controller 500 may allow the pilots to control all aspects of their respective robotic vehicles, and the system controller 500 may provide navigation assistance only to prevent collisions. For another example, in an “intermediate” race mode, the system controller 500 may allow the pilots to control some aspects (such as left/right directions and up/down directions) of the robotic vehicles, but maintain control of other navigational aspects of the robotic vehicles.

In addition, or in the alternative, execution of the navigation assistance instructions 554E may provide navigation assistance to selected robotic vehicles based on a detection of crashes or other hazards on the race course 200, and/or may provide navigation assistance to selected robotic vehicles based at least in part on detection of virtual contact with one or more virtual objects presented on the headset 422 or the display 472.

The processor 520 may execute the trajectory modification instructions 554G to modify the optimal trajectory for a selected robotic vehicle based at least in part on the determined deviations. In addition, or in the alternative, the optimal trajectory may be modified based on one or more hazards detected in the race course, the presence of another robotic vehicle within a distance of the selected robotic vehicle, determined pilot preferences, or any combination thereof.

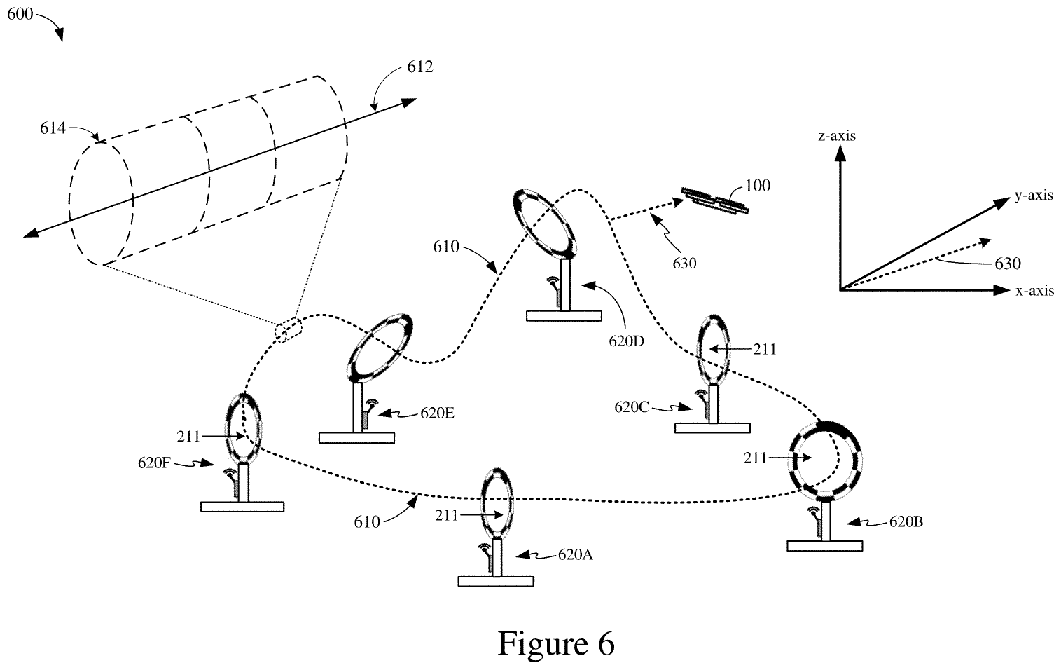

As mentioned above, the system controller 500 may generate an optimal trajectory through the race course 200. In some implementations, the optimal trajectory may be defined as a function of time. For example, FIG. 6 shows an illustration depicting an example optimal trajectory 610 that may be formed through a race course 600 defined by a number of gates 620A-620F. With reference to FIGS. 1-6, although only six gates 620A-620F are shown for simplicity, it is to be understood that any suitable number of gates may be used to define a race course, and the optimal trajectory 610 may be formed through any suitable number of gates. In some implementations, the gates 620A-620F may correspond to six of the gates 210A-210I that define the race course 200, and thus the optimal trajectory 610 described herein with respect to the race course 600 is equally applicable to the race course 200.

The optimal trajectory 610 may include a reference path 612 that extends through the openings 211 formed in center portions of the gates 620A-620F, and may include position information, velocity information, acceleration information, altitude information, pose information, and turning characteristics for robotic vehicles participating in the race. In some implementations, the optimal trajectory may be defined as a function of both time and position (e.g., as described with respect to FIG. 5). In some implementations, the optimal trajectory 610 may be used to create a virtual tunnel 614 (only a portion of the virtual tunnel 614 is shown in FIG. 6 for simplicity) indicating a maximum distance that a given robotic vehicle may deviate from various points along the reference path 612 (as a function of time). The virtual tunnel 614 may be of different diameters at various points along the reference path 612 to account for multiple possible trajectories. In some aspects, portions of the virtual tunnel 614 corresponding to turns may be greater in diameter than portions of the virtual tunnel 614 corresponding to straight sections, for example, to allow additional room for robotic vehicles to maneuver through turns.

The dynamics of robotic vehicles such as UAVs may be very complex, especially at high speeds, and the full states (such as position, velocity, altitude, and pose—as well as a number of derivatives thereof) of all UAVs participating in a race may be desired to predict collisions between the UAVs. Although forward simulation techniques may be used to predict or determine when to assume control of one or more of the UAVs to prevent such collisions, for purposes of discussion herein, deviations of the UAVs from an optimal trajectory are based on “distances” to avoid unnecessarily obfuscating aspects of this disclosure. However, one of ordinary skill in the art will understand that the “distances” as used herein with respect to determining whether a particular UAV has deviated from the optimal trajectory may refer to, or be indicative of, the full states of the UAVs.

In some aspects, the optimal trajectory 610 may be based on a number of parameters including, for example, the gate information of the race course (such as the locations, orderings, and poses of the gates 620A-620F), the capabilities of the robotic vehicles, and/or the skill levels and preferences of the pilots. In some aspects, the gate information may be embodied in a digital map generated by one of more of the robotic vehicles, by the system controller, or both.

In some implementations, the system controller 500 may use path planning, trajectory generation, and/or trajectory regulations when determining the optimal trajectory. In some aspects, path planning may be used to determine an optimal path for the robotic vehicle to follow through the race course while meeting mission objectives and constraints, such as obstacles or fuel requirements. The trajectory generation may be used to determine a series of flight commands or maneuvers for the robotic vehicle to follow a given path (such as the reference path 612 associated with the optimal trajectory 610). The trajectory regulations may be used to constrain a robotic vehicle within a distance of the optimal trajectory 610, for example, so that the robotic vehicle stays within the virtual tunnel.

The optimal trajectory 610 may be analyzed (e.g., by the system controller 500) to determine whether a given robotic vehicle is capable of flying through all of the gates 620A-620F, and the optimal trajectory 610 may be analyzed (e.g., by the system controller 500) to determine whether the skill level or preferences of a given pilot are sufficient to allow the pilot to successfully traverse a robotic vehicle through all of the gates 620A-620F. In some implementations, the system controller 500 may provide the optimal trajectory 610 to the robotic vehicles, which may use the optimal trajectory as navigation assistance and/or for autonomous flight through the race course. In implementations for which the optimal trajectory is defined as a function of both time and position, a robotic vehicle may use its own timing and position information to correlate its actual flight path with the reference path 612 defined by the optimal trajectory 610 in real-time. In addition, or in the alternative, determination of the optimal trajectory 610 may be based on a cost function representing a weighted combination of a number of factors including, for example, velocity, distances, time, battery life, race hazards, and the like.

In some implementations, a different optimal trajectory may be generated for each (at least some) robotic vehicle participating in a race, for example, so that each robotic vehicle may be provided with an optimal trajectory that is based on the specific capabilities of the robotic vehicle and/or on the specific skill level and preferences of the robotic vehicle's pilot. In some aspects, each robotic vehicle may store its optimal trajectory in a suitable memory. In this manner, each robotic vehicle may use the stored optimal trajectory to determine whether its actual flight path has deviated from its optimal trajectory 610 and/or to assist in autonomous flight around the race course. In addition, or in the alternative, the system controller 500 may perform learning operations during which the system controller 500 may leverage its learned capabilities of a robotic vehicle to increase the accuracy with which collision may be predicted.

The system controller 500 may provide navigation assistance to a pilot flying one of the robotic vehicles by comparing the actual flight path of the robotic vehicle with a corresponding optimal trajectory 610, generating various flight commands based on the comparison, and then providing the flight commands to the robotic vehicle. The robotic vehicle may use the flight commands to correct its actual flight path, for example, so that its actual flight path converges with the optimal trajectory 610. In some implementations, the system controller 500 may monitor (either periodically or continuously) the actual flight path of the robotic vehicle to determine whether the robotic vehicle has deviated from the optimal trajectory 610. In other implementations, each of the robotic vehicles may monitor (either periodically or continuously) its own flight path to determine whether the robotic vehicle has deviated from the optimal trajectory 610.

In some implementations, the system controller 500 may provide navigation assistance to a robotic vehicle if the actual flight path of the robotic vehicle deviates from the optimal trajectory 610 by more than a distance. The navigation assistance may include generating flight commands configured to compensate for the deviation between the robotic vehicle's actual flight path and the optimal trajectory 610. The flight commands, which may be transmitted to the robotic vehicle or to the pilot's vehicle controller (or both), may correct the robotic vehicle's flight path by causing the robotic vehicle to change its velocity, altitude, pose, and/or direction, for example, so that the robotic vehicle's actual flight path converges with the optimal trajectory 610. In some aspects, the system controller 500 may provide different levels of navigation assistance to different robotic vehicles participating in a race, for example, based on the capabilities of the robotic vehicles, based on the skill levels of the pilots, based on preferences of the pilots, or any combination thereof. In other aspects, the system controller 500 may select one of a number of different levels of navigation assistance to provide to the robotic vehicles based on the type of race.

Thereafter, the system controller 500 may continue monitoring the flight path of the robotic vehicle to ensure that the robotic vehicle does not deviate from the optimal trajectory 610 (such as by more than the distance). In some aspects, the system controller 500 may maintain a count value indicating how many times the robotic vehicle has deviated from the optimal trajectory 610 by more than the distance, and may take one or more actions if the count value reaches a threshold value. The one or more actions may include, for example, transmitting commands that cause the robotic vehicle to slow down, stop, or land, transmitting commands that cause the robotic vehicle to decrease its speed and/or its altitude, transmitting commands that allow the system controller 500 to assume control of the robotic vehicle, and other suitable commands.

In some implementations, the system controller 500 may generate a vector indicating a deviation between the robotic vehicle's actual flight path and the optimal trajectory 610. For example, a vector 630 that represents the 3-dimensional spatial deviation between actual flight path of the robotic vehicle 100 and the optimal trajectory 610 may be generated. The vector 630 may include spatial components corresponding to the x-axis, the y-axis, and the z-axis, for example, where the x-axis and the y-axis form a horizontal plane (such as a plane parallel to the ground) and the z-axis is orthogonal to the horizontal plane.

The navigation assistance may allow a less experienced pilot to participate in races with other more experienced pilots. In some implementations, the system controller 500 may selectively grant and/or revoke a pilot's control of a corresponding robotic vehicle based on a deviation between the robotic vehicle's actual flight path and the optimal trajectory 610. For example, as a pilot (e.g., 410) navigates the robotic vehicle 100 around the race course 600, the robotic vehicle 100 may capture video of the fiducial markers displayed on the gates 620A-620F and may transmit or stream the captured video to the system controller 500 and/or to an associated vehicle controller (not shown for simplicity). The system controller 500 may compare the robotic vehicle's actual flight path with the robotic vehicle's optimal trajectory 610. If the robotic vehicle 100 not has deviated from the optimal trajectory 610 by more than a distance, the system controller 500 may allow the pilot to retain full control of the robotic vehicle 100.

Conversely, if the system controller 500 determines that the robotic vehicle's actual flight path has deviated from the optimal trajectory 610 by more than the distance, the system controller 500 may take one or more actions such as, for example, transmitting commands that cause the robotic vehicle 100 to stop, or land, or return home, transmitting commands that cause the robotic vehicle 100 to change its velocity, altitude, direction, and/or pose, transmitting commands that allow the system controller 500 to assume control of the robotic vehicle 100, and/or other suitable commands. The system controller 500 may assume control of the robotic vehicle 100 in any suitable manner. In some aspects, the system controller 500 may disable communication links between the robotic vehicle 100 and its associated vehicle controller, and may establish a direct communication link between the robotic vehicle 100 and the system controller 500.

A pilot's field of view of a race course is typically limited, which may prevent less experienced pilots from participating in races. For example, FIG. 7A shows an illustration 700 depicting an example field of view 702 provided by a robotic vehicle (e.g., the robotic vehicle 100 of FIG. 1 or the UAVs D1-D4 of FIG. 2). With reference to FIGS. 1-7A, the field of view 702 provided by video cameras of the robotic vehicle 100 may allow the pilot (not shown for simplicity) to see a first gate 210A in the race course, but not a second gate 201B in the race course. The limited field of view 702 may not provide enough reaction time to less experienced pilots to successfully guide the robotic vehicle 100 through the second gate 201B.

Aspects of the present disclosure may increase a pilot's field of view by presenting one or more indications relating to the race to the pilot. In some implementations, a robotic vehicle (e.g., the robotic vehicle 100 of FIG. 1 or the UAVs D1-D4 of FIG. 2) may transmit streaming video comprising a first-person view (FPV) of the robotic vehicle in real-time as the robotic vehicle maneuvers through a race course, and a vehicle controller may present the video on a display for viewing by the pilot. The system controller 500 may increase the pilot's field of view by presenting a virtual map of the race course on the display, by presenting virtual arrows on the display, by presenting robotic vehicle position information on the display, by presenting robotic vehicle timing information on the display, or any combination thereof.

A virtual map presented on the display may allow the pilot to “see” the entire race course, for example, so that the pilot has a better perspective of upcoming gates and/or obstacles in the race course (as compared with the limited field of view 702). Virtual arrows presented on the display may indicate a direction of one or more subsequent gates in the race course. Position information of the robotic vehicle presented on the display may inform the pilot of the positions of other robotic vehicles in the race, for example, so that the pilot may be alerted as to the presence of another nearby robotic vehicle. Timing information of the robotic vehicle presented on the display may inform the pilot of the lap times and/or sub-lap times of other robotic vehicles in the race.

For example, FIG. 7B shows an illustration 710 depicting an example virtual arrow 711 presented on a display 715 of a robotic vehicle controller (such as the vehicle controller 420 of FIG. 4A, the vehicle controller 450 of FIG. 4B, or any other suitable vehicle controller). With reference to 1-7B, the display 715 may be the headset 422, the display 472, or any other suitable display or screen. In some aspects, a streaming video of a robotic vehicle's flight may be presented on the display 715, and a virtual arrow 711 may be displayed within the streaming video. The streaming video shows a first-person view of the robotic vehicle prior to traversing through the opening in a third gate of the race course 200, 600, for example, such that portions of the third gate's fiducial marker 212C are presented on an outer periphery of the display 715, and a next gate 210D in the race course 200 is presented within an inner left portion of the display 715. The virtual arrow 711 is oriented in the direction of the next gate 210D, for example, to indicate the direction in which the robotic vehicle should fly to reach the next gate 210D. In this manner, the FPV video presented on the display 715 may be augmented with the virtual arrow 711 to inform the pilot as to the direction of the next gate 210D.

Although not shown for simplicity, additional virtual arrows may also be presented on the display to indicate the directions of additional gates of a race course. Further, although a virtual map and positions of other robotic vehicles are not shown for simplicity, it is to be understood that aspects of the present disclosure can include the presentation of the virtual map and the positions of other robotic vehicles on the display 715 for viewing by the pilot, for example, in a manner similar to the presentation of the virtual arrow 711 on the display 715.

As mentioned above, the FPV video of a robotic vehicle presented to the pilot on a display (such as the headset 422 of FIG. 4A or the display 472) may be augmented with one or more virtual objects. In some implementations, the virtual objects may overlay the FPV video that is presented on the display, for example, so that the virtual objects appear within the actual video streamed from the camera of a robotic vehicle. The virtual objects may include gaming elements such as virtual obstacles and virtual rewards that can reward and/or penalize a pilot of a robotic vehicle if the robotic vehicle “hits” one of the virtual obstacles, may be virtual gates that can be used to re-define or alter the race course, and/or may be virtual robotic vehicles with which the “real” robotic vehicle may race.

The virtual obstacles may be displayed within the FPV video presented on a display of a vehicle controller, and the vehicle controller may be configured to determine if the pilot's robotic vehicle makes virtual contact with one of the virtual obstacles. In some implementations, if the robotic vehicle controller detects a virtual contact between the robotic vehicle and a virtual obstacle, the robotic vehicle controller may penalize the pilot by taking one or more actions such as, for example, decreasing a flight capability of the robotic vehicle, deducting points from the pilot's score, adding an amount of time to a lap time of the robotic vehicle, or any combination thereof. In some aspects, decreasing a flight capability of the robotic vehicle may include decreasing a maximum velocity of the robotic vehicle, decreasing a maximum altitude of the robotic vehicle, decreasing turning capabilities of the robotic vehicle (such as decreasing maximum pitch, decreasing maximum roll, and decreasing maximum yaw), or any combination thereof.

The virtual rewards may also be displayed within the FPV video presented on the display of the vehicle controller, and the vehicle controller may be configured to determine if the pilot's robotic vehicle makes virtual contact with one of the virtual rewards. In some implementations, if the vehicle controller detects a virtual contact between the robotic vehicle and a virtual reward, the vehicle controller may reward the pilot by taking one or more actions such as, for example, increasing a flight capability of the robotic vehicle, adding points to the pilot's score, subtracting an amount of time from a lap time of the robotic vehicle, or any combination thereof. In some aspects, increasing a flight capability of the robotic vehicle may include increasing a maximum velocity of the robotic vehicle, increasing a maximum altitude of the robotic vehicle, increasing turning capabilities of the robotic vehicle (such as increasing maximum pitch, increasing maximum roll, and increasing maximum yaw), or any combination thereof.

In addition, or in the alternative, the system controller 500 may be configured to determine if a robotic vehicle makes virtual contact with a virtual obstacle, and in response thereto may penalize the pilot if the virtual object is a virtual obstacle or may reward the pilot if the virtual object is a virtual reward.

FIG. 7C shows an illustration 720 depicting two example virtual objects that may be presented on the display 715 of a vehicle controller. With reference to FIGS. 1-7C, the display 715 may be the headset 422, the display 472, or any other suitable display or screen. The vehicle controller may be the vehicle controller 420, the vehicle controller 450, or any other suitable vehicle controller. In some aspects, a streaming video of a robotic vehicle's flight may be presented on the display 715, and a virtual obstacle 722 and a virtual reward 723 may be displayed within the streaming video. More specifically, the streaming video shows a first-person view of the robotic vehicle approaching the gate 210F of the race course 200, 600, with the next gate 210G shown in a right portion of the display 715. The virtual obstacle 722 and the virtual reward 723 are displayed between the gates 210F and 210G, for example, such that the virtual obstacle 722 is positioned on the reference path 612 between the gates 210F and 210G, and the virtual reward 723 is positioned to the left of the reference path 612 between the gates 210F and 210G. Thus, for the example of the illustration 720, a pilot may need to deviate from the reference path 612 to avoid hitting the virtual obstacle 722 and to pick-up the virtual reward 723.

The vehicle controller may detect a virtual contact between the robotic vehicle and the virtual obstacle 722 or the virtual reward 723 (or both). As discussed, if a virtual contact is detected between the robotic vehicle and the virtual obstacle 722, the pilot (or the robotic vehicle) may be penalized, for example, by decreasing a flight capability of the robotic vehicle, subtracting points from the pilot's score, adding time to a lap time of the robotic vehicle, or any combination thereof. Conversely, if a virtual contact is detected between the robotic vehicle and the virtual reward 723, the pilot (or the robotic vehicle) may be rewarded, for example, by increasing a flight capability of the robotic vehicle, adding points to the pilot's score, subtracting time from a lap time of the robotic vehicle, or any combination thereof.

In some implementations, virtual contact between the robotic vehicle and the virtual obstacle 722 may be detected by determining whether the robotic vehicle's flight path intersects or collides with the virtual obstacle 722, and virtual contact between the robotic vehicle and the virtual reward 723 may be detected by determining whether the robotic vehicle's flight path intersects or collides with the virtual reward 723. In some aspects, the augmented video presented on the display 715 may be analyzed to determine whether a position of the robotic vehicle matches the position of the virtual obstacle 722 when detecting a presence of virtual contact between the robotic vehicle and the virtual obstacle 722. Virtual contact between the robotic vehicle and the virtual reward 723 may be detected in a similar manner.

FIG. 7D shows an illustration 730 depicting a virtual contact between the robotic vehicle and the virtual obstacle 722 of FIG. 7C. With reference to FIGS. 1-7D, streaming video of the robotic vehicle's flight may be presented on the display 715, and a virtual contact 732 may be displayed within the streaming video along the reference path 612. More specifically, the streaming video may show a first-person view of the robotic vehicle approaching the gate 210G of the race course 200, 600, and the virtual contact 732 is displayed on the reference path 612 between the gates 210F and 210G, for example, to indicate that the robotic vehicle has “contacted” the virtual obstacle 722.

In some aspects, other virtual gaming elements such as virtual missiles and virtual robotic vehicles may be displayed within the streaming video presented on the display 715. In some aspects, the pilot (or the robotic vehicle) may be penalized if virtual contact is detected between the robotic vehicle and a virtual missile or a virtual robotic vehicle, for example, in a manner similar to that described above with respect to virtual contact detected between the robotic vehicle and the virtual obstacle 722. In some implementations, the virtual robotic vehicles may be software-defined drones or objects that appear, at least on the display 715, to be participants in the race. In some aspects, the virtual robotic vehicles may have different characteristics and capabilities than each other and/or than the real robotic vehicle. For example, one virtual robotic vehicle may have superior handling, while another virtual robotic vehicle may have a higher top speed.

In addition, or in the alternative, a number of virtual gates may be displayed within the streaming video presented on the display of the vehicle controller, for example, to augment the actual race course with a virtual race course. In some implementations, the pilots may be required to maneuver their robotic vehicles through the virtual gates as well as the actual gates (such as the gates 210A-210I of the race course 200). For example, the race course 200 may be re-defined to include a number of virtual gates (such as in addition to the “real” gates 210A-210I) by displaying (or overlaying) the virtual gates within portions of the streaming video transmitted from each robotic vehicle participating in the race. In some aspects, an entire drone race course may be defined by virtual gates, for example, so that real gates are not needed to define the race course.

FIG. 8A shows an illustrative flow chart depicting an example operation 800 for implementing a race course for robotic vehicles (e.g., the robotic vehicle 100 of FIG. 1 or the UAVs D1-D4 of FIG. 2). For simplicity, the example operation 800 is described below with respect to implementing the race course 200 of FIG. 2. However, it to be understood that the example operation 800 may be used to implement any suitable race course (e.g., the race course 600 of FIG. 6 or another suitable course).

With reference to FIGS. 1-8A, the race course may be defined by a plurality of gates each including an opening through which the robotic vehicles traverse during a race (801). In some implementations, the openings of the plurality of gates may define a flight path through the race course. The gates and/or openings may be of any suitable shape including, for example, a circular gate, a square gate, a hexagonal gate, a triangular gate, or an elliptical gate. In some aspects, one or more of the gates may be of different shapes and/or sizes. In addition, or in the alternative, one or more of the openings may be of different shapes and/or sizes.

A fiducial marker may be displayed on each of the plurality of gates and configured to encode a location, an ordering, and a pose of the corresponding gate (802). In some implementations, each of the fiducial markers may be or may include a unique pattern presented around a perimeter of the opening of the corresponding gate, and the unique pattern may convey the encoded location, ordering, and pose of the corresponding gate to a video camera provided on each of the robotic vehicles. During a race, a robotic vehicle may use its camera to identify and capture images of the fiducial markers presented on the gates, and may use image recognition techniques to decode the locations, orderings, and poses of the gates conveyed by the unique patterns. In some aspects, the robotic vehicle may use the determined locations, orderings, and poses of the gates to determine its own position and pose during the race.

In some implementations, the openings of the plurality of gates may define a flight path through the race course (803). The flight path may provide a reference path or trajectory that can provide navigation assistance to the robotic vehicles' pilots. The reference path may be used to determine an optimal trajectory through the race course and/or a virtual tunnel indicating a maximum distance that a robotic vehicle may deviate from various points along the reference path. In some implementations, the optimal trajectory may be defined as a function of both time and position, for example, so that the robotic vehicle may correlate its actual flight path with the reference path defined by the optimal trajectory in real-time. In some aspects, the optimal trajectory and/or the virtual tunnel may be used by the robotic vehicles to adjust their flight path through the race course.

In some aspects, the system controller 500 may provide different levels of navigation assistance to different robotic vehicles participating in a race, for example, based on the capabilities of the robotic vehicles, based on the skill levels of the pilots, based on preferences of the pilots, or any combination thereof. In other aspects, the system controller 500 may select one of a number of different levels of navigation assistance to provide to the robotic vehicles based on the type of race. For one example, in a basic “slot car” race mode, the system controller 500 may allow the pilots to control only the speed of their respective robotic vehicles, with all other aspects of the robotic vehicles' flights controlled by the system controller 500. For another example, in a “guardian” race mode, the system controller 500 may allow the pilots to control all aspects of their respective robotic vehicles, and may provide navigation assistance only to prevent collisions. For another example, in an “intermediate” race mode, the system controller 500 may allow the pilots to control some aspects (such as left/right directions and up/down directions) of the robotic vehicles, but maintain control of other navigational aspects of the robotic vehicles.

A wireless network may be formed using one or more wireless transceivers provided on each of a number of the gates (804). The wireless network may facilitate wireless communications between the gates that define the race course, wireless communications between the system controller 500 and each of the robotic vehicles participating in the race, wireless communications between the robotic vehicles and their associated vehicle controllers, wireless communications with a number of spectators, or any combination thereof. The wireless network may be any suitable wireless network including, for example, a Wi-Fi network, a peer-to-peer (P2P) wireless network, a mesh network, a cellular network, or any combination thereof.

The wireless network may also facilitate wireless communications between the robotic vehicles participating in the race. In some aspects, the robotic vehicles may exchange wireless signals with each other using peer-to-peer wireless communications. In other aspects, the robotic vehicles may exchange wireless signals with each other on a dedicated wireless channel or communication link.

In addition, or in the alternative, each of the robotic vehicles may periodically transmit wireless signals from which the other robotic vehicles may determine proximity information. Each of the robotic vehicles may use the proximity information to determine a presence of other nearby robotic vehicles. In some aspects, the proximity information may indicate that another robotic vehicle is rapidly approaching, that another robotic vehicle is about to perform a cut-off maneuver, that a collision is likely, and so on. In addition, or in the alternative, the wireless signals transmitted from one or more of the robotic vehicles may provide rang-rate information that can be used to determine whether two or more robotic vehicles are headed for a collision with each other. In some implementations, the robotic vehicles may use short-range, low-energy wireless signals (such as Bluetooth Low Energy signals) to determine proximity information.

The locations, the orderings, and the poses of the gates may be transmitted to the robotic vehicles via the wireless network (805). In this manner, each of the robotic vehicles participating in the race may store the locations, orderings, and poses of all the gates that define the race course. The stored gate information may be used by the robotic vehicles to identify each of the gates based on the unique patterns provided on the fiducial markers displayed on the gates.

The gates may send the locations, the orderings, and the poses of the gates to each other via the wireless network (806). In this manner, each gate may be aware of the locations, orderings, and poses of other gates that define the race course.

The gates may transmit their locations, orderings, and poses to the system controller, and may receive commands from the system controller 500 (807). The gates may also transmit robotic vehicle flight information to the system controller 500. The robotic vehicle flight information may include the positions, poses, velocities, altitudes, and ordering of the robotic vehicles participating in the race. In some implementations, the gates may determine the robotic vehicle flight information based on video captured by cameras provided on the gates, timing information determined by the beam-breaking mechanisms, flight information provided by the robotic vehicles, flight information provided by the system controller 500, or any combination thereof.

FIG. 8B shows an illustrative flow chart depicting another example operation 810 for implementing a race course for robotic vehicles (e.g., the robotic vehicle 100 of FIG. 1 or the UAVs D1-D4 of FIG. 2). The example operation 810 is described below with respect to implementing a race between robotic vehicles using the race course 200 of FIG. 2. However, it to be understood that the example operation 810 may be used to implement any suitable race between any number of suitable robotic vehicles.

The race course may be defined by a plurality of gates each including an opening through which the robotic vehicles traverse during a race through the race course (801), and a fiducial marker may be displayed on each of the plurality of gates to encode a location, an ordering, and a pose of the corresponding gate (802). In some implementations, each of the plurality of fiducial markers includes a unique pattern presented around a perimeter of the opening of the corresponding gate. A flight path may be defined through the openings of the plurality of gates (803). The flight path may provide a reference path or trajectory that can provide navigation assistance to the robotic vehicles' pilots. In some implementations, the reference path may be used to determine an optimal trajectory through the race course and/or a virtual tunnel indicating a maximum distance that a robotic vehicle may deviate from various points along the reference path. In some aspects, the optimal trajectory and/or the virtual tunnel may be used by the robotic vehicles to adjust their flight path through the race course 200. In addition, or in the alternative, the optimal trajectory may be defined as a function of time and position so that a robotic vehicle may correlate its actual flight path with the reference path defined by the optimal trajectory in real-time. In some aspects, deviations between the robotic vehicle's actual flight path and the optimal trajectory may be determined, at least in part, as a function of both time and distance.

One or more of the plurality of gates may determine the times at which each of the robotic vehicles traverses through the opening in a corresponding one of the gates (811). In some aspects, a beam-breaking mechanism may be provided on each of the one or more of the plurality of gates. The times determined by the beam-breaking mechanisms may be used to determine lap times or intervals for each of the robotic vehicles participating in the race.

Sub-lap timing information may be determined for each of the robotic vehicles based at least in part on the times determined by the beam-breaking mechanisms and the orderings of the plurality of gates (812). The sub-lap timing information may be used to determine the relative positions and velocities of the robotic vehicles participating in the race, and to provide real-time updates regarding the relative ordering of the robotic vehicles (such as first place, second place, and so on). In some implementations, the sub-lap timing information may be transmitted to the system controller 500 (813).

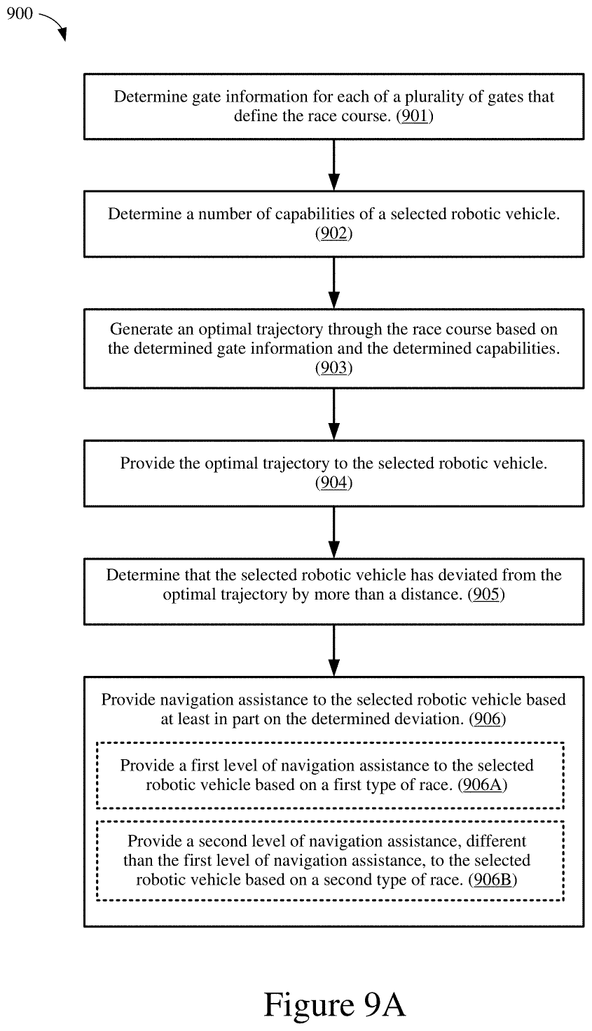

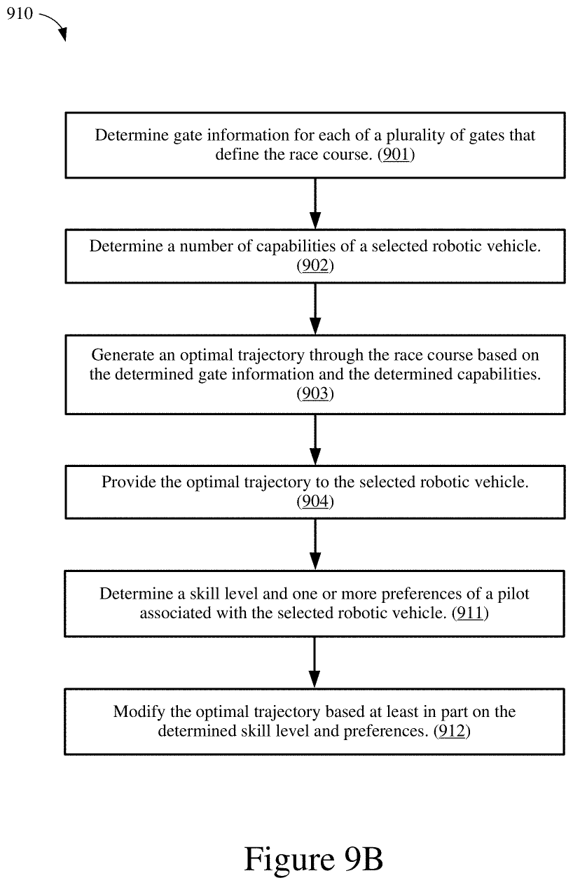

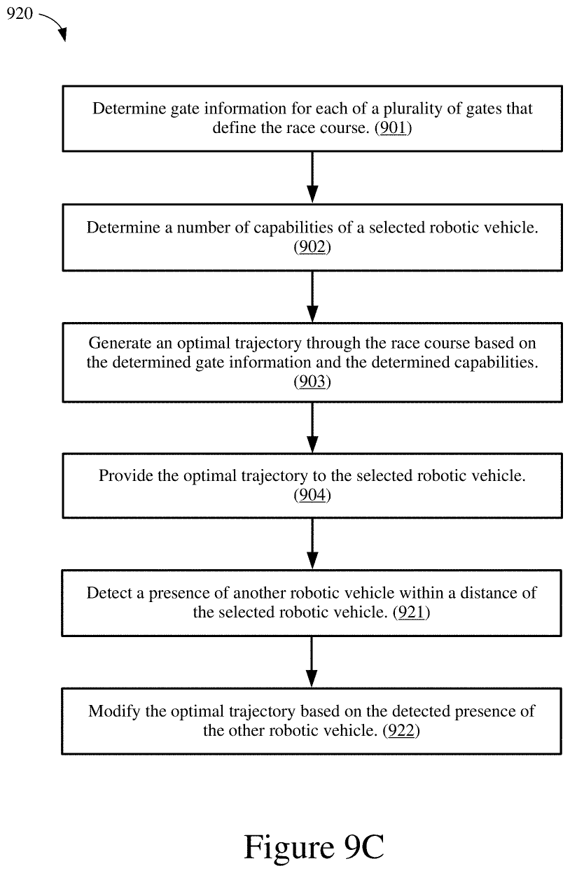

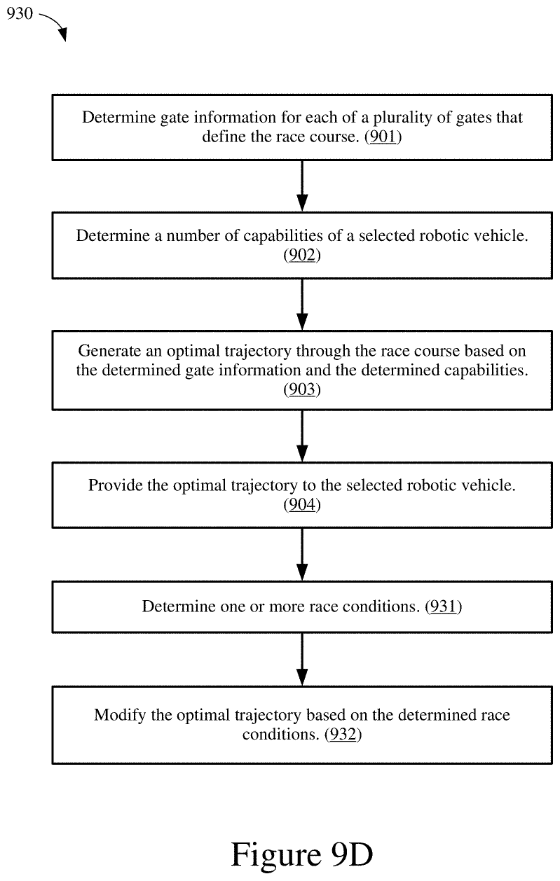

FIG. 9A shows an illustrative flow chart depicting an example operation 900 for guiding a robotic vehicle (e.g., the robotic vehicle 100 of FIG. 1 or the UAVs D1-D4 of FIG. 2) through a race course. The example operation 900 is described below with respect to guiding a robotic vehicle around the race course 200 of FIG. 2. However, it to be understood that the example operation 900 may be used to guide any suitable robotic vehicle around any suitable race course defined by any number of suitable gates. Further, although described below with respect to the system controller 500 of FIG. 5 and the optimal trajectory 610 of FIG. 6, the operation 900 may be performed by any suitable system controller (such as the system controller 250 of FIG. 2) and may be used to generate any suitable optimal trajectory through a race course.

With reference to FIGS. 1-9A, the system controller 500 may determine gate information for each of a plurality of gates that define the race course (901). The gate information may include at least a location, an ordering, and a pose of the corresponding gate. In some implementations, each of the gates may include an opening through which the robotic vehicles traverse during the race, and may include a fiducial marker encoding gate information for the corresponding gate. In some aspects, each of the fiducial markers may include a unique pattern presented around a perimeter of the opening of the corresponding gate. In addition, or in the alternative, the openings of the plurality of gates may define a flight path through the race course.

The system controller 500 may determine a number of capabilities of a selected robotic vehicle (902). In some implementations, the number of capabilities of the selected robotic vehicle may include one or more of a battery life of the selected robotic vehicle, a maximum velocity of the selected robotic vehicle, a maximum altitude of the selected robotic vehicle, a maximum acceleration of the selected robotic vehicle, and turning characteristics of the selected robotic vehicle.

The system controller 500 may generate an optimal trajectory through the race course based on the determined gate information and the determined capabilities of the selected robotic vehicle (903). The optimal trajectory may include a reference path for the selected robotic vehicle to follow through the race course. In some implementations, the optimal trajectory may include position information, velocity information, acceleration information, altitude information, pose information, and turning characteristics for the selected robotic vehicle. In some aspects, the turning characteristics may refer to one or more rotational aspects of the robotic vehicle associated with changing a flight such as, for example, pitch, roll, and yaw.

In some implementations, the optimal trajectory may be defined as a function of time so that the actual position, velocity, acceleration, altitude, and pose of a particular robotic vehicle may be compared with the optimal trajectory at any instant in time, during any period of time, or continuously. In this manner, the robotic vehicle may correlate its actual flight path with the reference path defined by the optimal trajectory in real-time.

In addition, or in the alternative, the system controller 500 may use the optimal trajectory to create a virtual tunnel indicating a maximum distance that a given robotic vehicle may deviate from various points along the reference path. The virtual tunnel may be of different diameters at various points along the reference path to account for multiple possible trajectories.

The system controller 500 may provide the optimal trajectory to the selected robotic vehicle (904). In some implementations, the system controller 500 may transmit the optimal trajectory to the selected robotic vehicle using the wireless network formed by wireless transceivers provided on a number of the gates that define the race course. The selected robotic vehicle may use the optimal trajectory for navigation assistance, for autonomous flight around the race course, or both.

The system controller 500 may determine that the selected robotic vehicle has deviated from the optimal trajectory by more than a distance (905). In some aspects, deviations between the robotic vehicle's actual flight path and the optimal trajectory may be determined, at least in part, as a function of both time and distance.

The system controller 500 may provide navigation assistance to the selected robotic vehicle based at least in part on the determined deviation (906). In some implementations, the system controller 500 may select one of a number of different levels of navigation assistance to provide to the robotic vehicles based on the type of race. In some aspects, the system controller 500 may provide a first level of navigation assistance to the selected robotic vehicle based on a first type of race (906A), and may provide a second level of navigation assistance, different than the first level of navigation assistance, to the selected robotic vehicle based on a second type of race (906B). For one example, in a basic “slot car” race mode, the system controller 500 may allow the pilots to control only the speed of their respective robotic vehicles, with all other aspects of the robotic vehicles' flights controlled by the system controller. For another example, in a “guardian” race mode, the system controller 500 may allow the pilots to control all aspects of their respective robotic vehicles, and may provide navigation assistance only to prevent collisions. For another example, in an “intermediate” race mode, the system controller 500 may allow the pilots to control some aspects (such as left/right directions and up/down directions) of the robotic vehicles, but maintain control of other navigational aspects of the robotic vehicles.

In other implementations, the system controller 500 may provide different levels of navigation assistance to different robotic vehicles participating in a race, for example, based on the capabilities of the robotic vehicles, based on the skill levels of the pilots, based on preferences of the pilots, or any combination thereof.

If the selected robotic vehicle has not deviated from the optimal trajectory by more than the distance, the system controller 500 may not interfere with or modify flight operations of the selected robotic vehicle. Conversely, if the selected robotic vehicle has deviated from the optimal trajectory by more than the distance, the system controller 500 may provide the navigation assistance to the selected robotic vehicle. In some implementations, the system controller 500 may compare the actual flight path of the selected robotic vehicle with the optimal trajectory (or with the reference path) to generate a vector indicating a deviation between the robotic vehicle's actual flight path and the optimal trajectory, and may use the generated vector to determine whether the actual flight path of the selected robotic vehicle has deviated from the optimal trajectory by more than the distance. The vector may represent the 3-dimensional spatial deviation between actual flight path of the selected robotic vehicle and the optimal trajectory, for example, as described above with respect to FIG. 6. In some aspects, the vector representing the 3-dimensional spatial deviation between actual flight path of the selected robotic vehicle and the optimal trajectory may also be expressed as a function of time.

In some implementations, the navigation assistance may be configured to cause the robotic vehicle to change its velocity, altitude, direction, and/or pose so that the flight path of the selected robotic vehicle converges with the optimal trajectory (or with the reference path). The navigation assistance may include assuming control of the selected robotic vehicle, causing the selected robotic vehicle to stop, land, or return home, changing a velocity, altitude, direction, and/or pose of the selected robotic vehicle, restricting one or more flight parameters of the selected robotic vehicle, or any combination thereof.

In other implementations, the system controller 500 may restrict one or more flight parameters of the selected robotic vehicle based on the determined deviation. For example, if the selected robotic vehicle deviates from the optimal trajectory by more than the distance, the system controller 500 may limit at least one of a velocity, an acceleration, an altitude, and turning characteristics of the selected robotic vehicle. In addition, or in the alternative, the system controller 500 may decrease the distance from which the selected robotic vehicle may deviate from the optimal trajectory.

FIG. 9B shows an illustrative flow chart depicting another example operation 910 for guiding a robotic vehicle (e.g., the robotic vehicle 100 of FIG. 1 or the UAVs D1-D4 of FIG. 2) through a race course. The example operation 910 is described below with respect to guiding a robotic vehicle around the race course 200 of FIG. 2. However, it to be understood that the example operation 910 may be used to guide any suitable robotic vehicle around any suitable race course defined by any number of suitable gates. Further, although described below with respect to the system controller 500 of FIG. 5 and the optimal trajectory 610 of FIG. 6, the operation 910 may be performed by any suitable system controller (such as the system controller 250 of FIG. 2) and may be used to generate any suitable optimal trajectory.

With reference to FIGS. 1-9B, after performing the steps 901-904, the system controller 500 may determine a skill level and one or more preferences of a pilot associated with the selected robotic vehicle (911). In some aspects, the skill level may be a value on a standard skill range (such as 4.0 on a scale of 0 to 5). In other aspects, the skill level may be relative to the skill levels of other pilots participating in the race (such as +1 relative to the other pilots). The pilot preferences may include a risk level of the pilot, a desired competitive level of the pilot, or any other suitable preference that may be used to determine a degree of difficulty (or a degree of ease) to consider when modifying the optimal trajectory). In some aspects, the system controller 500 may retrieve the pilot preferences from the database 552 of FIG. 5.

The system controller 500 may modify the optimal trajectory based at least in part on the determined skill level and preferences (912). In some implementations, the determined skill level and pilot preferences may be analyzed to determine the degree to which the optimal trajectory should be modified. In addition, or in the alternative, the system controller 500 may determine whether the modified optimal trajectory is consistent with the determined skill level and pilot preferences, for example, to ensure that the pilot is capable of navigating a robotic vehicle through the race course using the modified optimal trajectory.

FIG. 9C shows an illustrative flow chart depicting another example operation 920 for guiding a robotic vehicle (e.g., the robotic vehicle 100 of FIG. 1 or the UAVs D1-D4 of FIG. 2) through a race course. The example operation 920 is described below with respect to guiding a robotic vehicle around the race course 200 of FIG. 2. However, it to be understood that the example operation 920 may be used to guide any suitable robotic vehicle around any suitable race course defined by any number of suitable gates. Further, although described below with respect to the system controller 500 of FIG. 5 and the optimal trajectory 610 of FIG. 6, the operation 920 may be performed by any suitable system controller (such as the system controller 250 of FIG. 2) and may be used to generate any suitable optimal trajectory.

With reference to FIGS. 1-9C, after performing the steps 901-904, the system controller 500 may detect a presence of another robotic vehicle within a distance of the selected robotic vehicle (921), and may modify the optimal trajectory based on the detected presence of the other robotic vehicle (922). If the other robotic vehicle is not within the distance of the selected robotic vehicle, the system controller 500 may not interfere with the flight operations of the selected robotic vehicle. Conversely, if the other robotic vehicle is within the distance of the selected robotic vehicle, the system controller 500 may modify the optimal trajectory for the selected robotic vehicle, for example, to generate a modified optimal trajectory configured to avoid a collision between the selected robotic vehicle and the other robotic vehicle.

In some implementations, the system controller 500 may compare the flight path of the selected robotic vehicle with the flight path of the other robotic vehicle to determine whether the flight paths will intersect each other at the same time. In other implementations, the system controller 500 may compare streaming videos provided by the selected robotic vehicle and the other robotic vehicle to determine a likelihood of a collision and/or to estimate the distance between the selected robotic vehicle and the other robotic vehicle.

FIG. 9D shows an illustrative flow chart depicting another example operation 930 for guiding a robotic vehicle (e.g., the robotic vehicle 100 of FIG. 1 or the UAVs D1-D4 of FIG. 2) through a race course. The example operation 930 is described below with respect to guiding a robotic vehicle around the race course 200 of FIG. 2. However, it to be understood that the example operation 930 may be used to guide any suitable robotic vehicle around any suitable race course defined by any number of suitable gates. Further, although described below with respect to the system controller 500 of FIG. 5 and the optimal trajectory 610 of FIG. 6, the operation 930 may be performed by any suitable system controller (such as the system controller 250 of FIG. 2) and may be used to generate any suitable optimal trajectory.

With reference to FIGS. 1-9D, after performing the steps 901-904, the system controller 500 may determine one or more race hazards (931), and may modify the optimal trajectory based on the determined race hazards (932). The one or more race hazards include at least one of a crash on the race course, a presence of obstacles on the race course, and a change in capabilities of the selected robotic vehicle. In some implementations, video cameras coupled to or associated with the gates of the race course may transmit video of areas in the vicinities of the gates, and the system controller 500 may analyze the received video to detect an occurrence of a crash or the presence of an obstacle in the race course. In response thereto, the system controller 500 may modify the optimal trajectory to generate a modified optimal trajectory configured to guide the selected robotic vehicle away from the detected crash or obstacle.

In some implementations, the selected robotic vehicle may inform the system controller 500 of any change in the capabilities of the selected robotic vehicle, for example, by transmitting a capability status signal to the system controller 500. In response thereto, the system controller 500 may modify the optimal trajectory to generate a modified optimal trajectory that compensates for the change in the selected robotic vehicle's capabilities.

FIG. 10 shows an illustrative flow chart depicting an example operation 1000 for augmenting a robotic vehicle (e.g., the robotic vehicle 100 of FIG. 1 or the UAVs D1-D4 of FIG. 2) with one or more virtual features. The example operation 1000 is described below with respect to the vehicle controller 450 of FIG. 4B and the example display 715 depicted in FIGS. 7A-7D. However, it to be understood that the example operation 1000 may be used with any suitable robotic vehicle controller and with any suitable display (such as the headset 422 of FIG. 4A).

With reference to FIGS. 1-10, streaming video comprising a first-person view (FPV) of a robotic vehicle 100 is presented on a display of the vehicle controller 450 as the robotic vehicle 100 traverses a course (1001). For example, streaming video of the robotic vehicle 100 presented on the display 715 shows a first-person view of the robotic vehicle 100 approaching the gate 210F of the course 200, with the next gate 210G shown in a right portion of the display 715. In some implementations, the streaming video may be transmitted from the robotic vehicle 100 to the vehicle controller 450 and to the system controller 500.

A virtual object may be presented on the display 715 of the vehicle controller 450 (1002). The virtual object may be displayed within (or overlaid on) the streaming video presented on the display, for example, so that the virtual object appears to be present within the first-person view of the robotic vehicle 100 presented to the pilot. For example, a virtual obstacle 722 and a virtual reward 723 may be displayed within the streaming video presented to the pilot on the display 715.

A virtual contact between the robotic vehicle 100 and the virtual object may be detected (1003). In some implementations, the vehicle controller 450 may detect the virtual contact between the robotic vehicle 100 and the virtual object, for example, by determining whether the robotic vehicle's flight path intersects or collides with the virtual object. In some aspects, the vehicle controller 450 may analyze the augmented video presented on the display 715 to determine whether a position of the robotic vehicle 100 matches the position of the virtual object at a given instance in time. In other implementations, the system controller 500 may detect the virtual contact between the robotic vehicle 100 and the virtual object.

In response to detecting the virtual contact, the robotic vehicle 100 may be penalized if the virtual object is a virtual obstacle and/or may be rewarded if the virtual object is a virtual reward (1004). In some implementations, the robotic vehicle 100 may be penalized by reducing a flight capability of the robotic vehicle 100. In some aspects, the flight capability may be reduced by decreasing a maximum velocity of the robotic vehicle 100, by decreasing a maximum altitude of the robotic vehicle 100, and by reducing turning abilities of the robotic vehicle 100 (such as by decreasing a maximum pitch of the robotic vehicle, by decreasing a maximum roll of the robotic vehicle, by decreasing a maximum yaw of the robotic vehicle), or any combination thereof. In addition, or in the alternative, the robotic vehicle 100 may be penalized by deducting points from a score of the robotic vehicle 100 and/or by adding an amount of time to a lap time of the robotic vehicle 100. In addition, or in the alternative, the robotic vehicle 100 may be penalized by adjusting a score and/or lap time of one or more of the other robotic vehicles (e.g., adding points to the scores of the other robotic vehicles, subtracting time from the lap times of the other robotic vehicles, etc.).

In some implementations, the robotic vehicle 100 may be rewarded by enhancing a flight capability of the robotic vehicle 100. In some aspects, the flight capability may be enhanced by increasing a maximum velocity of the robotic vehicle 100, by increasing a maximum altitude of the robotic vehicle 100, and by increasing turning abilities of the robotic vehicle 100 (such as by increasing a maximum pitch of the robotic vehicle, by increasing a maximum roll of the robotic vehicle, by increasing a maximum yaw of the robotic vehicle), or any combination thereof. In some implementations, the robotic vehicle 100 may be rewarded by providing navigation assistance to a pilot of the robotic vehicle 100.

In some implementations, the robotic vehicle 100 may be rewarded by changing the course in a manner that provides an advantage to the robotic vehicle 100 (e.g., opening a shortcut for the robotic vehicle 100 to circumvent some of the course or allowing the robotic vehicle 100 to skip one or more of the gates that define the course), and/or the robotic vehicle 100 may be penalized by changing the course in a manner that provides an advantage to other robotic vehicles (e.g., opening a shortcut for the other robotic vehicles to circumvent some of the course or allowing the other robotic vehicles to skip one or more of the gates that define the course).

In addition, or in the alternative, the robotic vehicle 100 may be rewarded with an advantage that causes other robotic vehicles to slow down temporarily (and/or by allowing the robotic vehicle 100 to speed up temporarily) or otherwise provides a performance/capability advantage to the robotic vehicle 100 relative to the other robotic vehicles, and/or the robotic vehicle 100 may be penalized with a disadvantage that causes other robotic vehicles to speed up temporarily (and/or by causing the robotic vehicle 100 to slow down temporarily) or otherwise provides a performance/capability advantage to the other robotic vehicles relative to the robotic vehicle 100.

In some implementations, a virtual robotic vehicle may be presented on the display 715 (1005), and a race between the virtual robotic vehicle and the robotic vehicle 100 may be implemented (1006). In some aspects, the vehicle controller 450 may compare the flight path and timing information of the robotic vehicle 100 with a flight path and timing information of the virtual robotic vehicle to determine whether the robotic vehicle 100 or the virtual robotic vehicle has a faster lap time. In other aspects, the system controller 500 may compare the flight path and timing information of the robotic vehicle 100 with a flight path and timing information of the virtual robotic vehicle to determine whether the robotic vehicle 100 or the virtual robotic vehicle has a faster lap time.

In addition, or in the alternative, a number of virtual gates may be presented on the display 715 (1007), and the course may be re-defined to include the number of virtual gates (1008). In some aspects, the vehicle controller 450 may compare the flight path of the robotic vehicle 100 with the positions of the virtual gates to determine whether the robotic vehicle 100 successfully traverses the virtual gates. In other aspects, the system controller 500 may compare the flight path of the robotic vehicle 100 with the positions of the virtual gates to determine whether the robotic vehicle 100 successfully traverses the virtual gates.

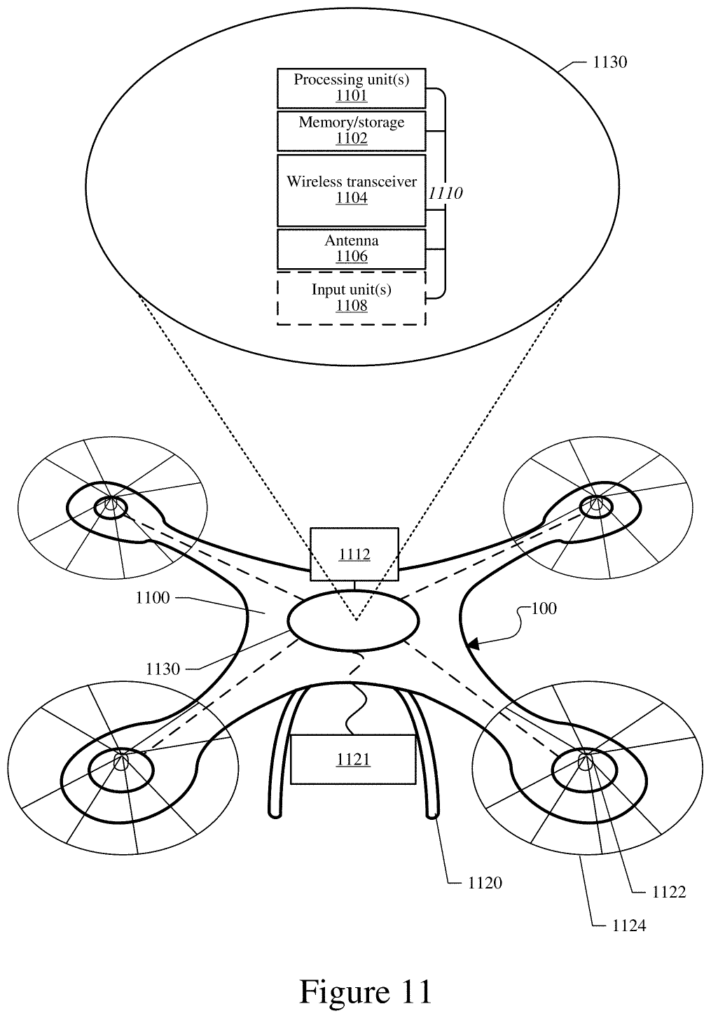

Various embodiments may be implemented within a variety of robotic vehicles, an example of which in the form of a four-rotor UAV (or any other multi-rotor UAV) is illustrated in FIG. 11 that is suitable for use with various embodiments. With reference to FIGS. 1-11, the robotic vehicle 100 may include a body 1100 (i.e., fuselage, frame, etc.) that may be made out of any combination of plastic, metal, or other materials suitable for flight. The body 1100 may include a processor 1130 that is configured to monitor and control the various functionalities, subsystems, and/or other components of the robotic vehicle 100. For example, the processor 1130 may be configured to monitor and control various functionalities of the robotic vehicle 100, such as any combination of modules, software, instructions, circuitry, hardware, etc. related to propulsion, navigation, power management, sensor management, and/or stability management.

The processor 1130 may include one or more processing unit(s) 1101, such as one or more processors configured to execute processor-executable instructions (e.g., applications, routines, scripts, instruction sets, etc.), a memory and/or storage unit 1102 configured to store data (e.g., flight plans, obtained sensor data, received messages, applications, etc.), and a wireless transceiver 1104 and antenna 1106 for transmitting and receiving wireless signals (e.g., a Wi-Fi® radio and antenna, Bluetooth®, RF, etc.). In some embodiments, the robotic vehicle 100 may also include components for communicating via various wide area networks, such as cellular network transceivers or chips and associated antenna (not shown). In some embodiments, the processor 1130 of the robotic vehicle 100 may further include various input units 1108 for receiving data from human operators and/or for collecting data indicating various conditions relevant to the robotic vehicle 100. For example, the input units 1108 may include camera(s), microphone(s), location information functionalities (e.g., a global positioning system (GPS) receiver for receiving GPS coordinates), flight instruments (e.g., attitude indicator(s), gyroscope(s), accelerometer(s), altimeter(s), compass(es), etc.), keypad(s), etc. The various components of the processor 1130 may be connected via a bus 1110 or another similar circuitry.

The body 1100 may include landing gear 1120 of various designs and purposes, such as legs, skis, wheels, pontoons, etc. The body 1100 may also include a payload mechanism 1121 configured to hold, hook, grasp, envelope, and otherwise carry various payloads, such as boxes. In some embodiments, the payload mechanism 1121 may include and/or be coupled to actuators, tracks, rails, ballasts, motors, and other components for adjusting the position and/or orientation of the payloads being carried by the robotic vehicle 100. For example, the payload mechanism 1121 may include a box moveably attached to a rail such that payloads within the box may be moved back and forth along the rail. The payload mechanism 1121 may be coupled to the processor 1130 and thus may be configured to receive configuration or adjustment instructions. For example, the payload mechanism 1121 may be configured to engage a motor to re-position a payload based on instructions received from the processor 1130.

The robotic vehicle 100 may be of a helicopter design that utilizes one or more rotors 1124 driven by corresponding motors 1122 to provide lift-off (or take-off) as well as other aerial movements (e.g., forward progression, ascension, descending, lateral movements, tilting, rotating, etc.). The robotic vehicle 100 may utilize various motors 1122 and corresponding rotors 1124 for lifting off and providing aerial propulsion. For example, the robotic vehicle 100 may be a “quad-copter” that is equipped with four motors 1122 and corresponding rotors 1124. The motors 1122 may be coupled to the processor 1130 and thus may be configured to receive operating instructions or signals from the processor 1130. For example, the motors 1122 may be configured to increase rotation speed of their corresponding rotors 1124, etc. based on instructions received from the processor 1130. In some embodiments, the motors 1122 may be independently controlled by the processor 1130 such that some rotors 1124 may be engaged at different speeds, using different amounts of power, and/or providing different levels of output for moving the robotic vehicle 100. For example, motors 1122 on one side of the body 1100 may be configured to cause their corresponding rotors 1124 to spin at higher rotations per minute (RPM) than rotors 1124 on the opposite side of the body 1100 in order to balance the robotic vehicle 100 burdened with an off-centered payload.

The body 1100 may include a power source 1112 that may be coupled to and configured to power the various other components of the robotic vehicle 100. For example, the power source 1112 may be a rechargeable battery for providing power to operate the motors 1122, the payload mechanism 1121, and/or the units of the processor 1130.

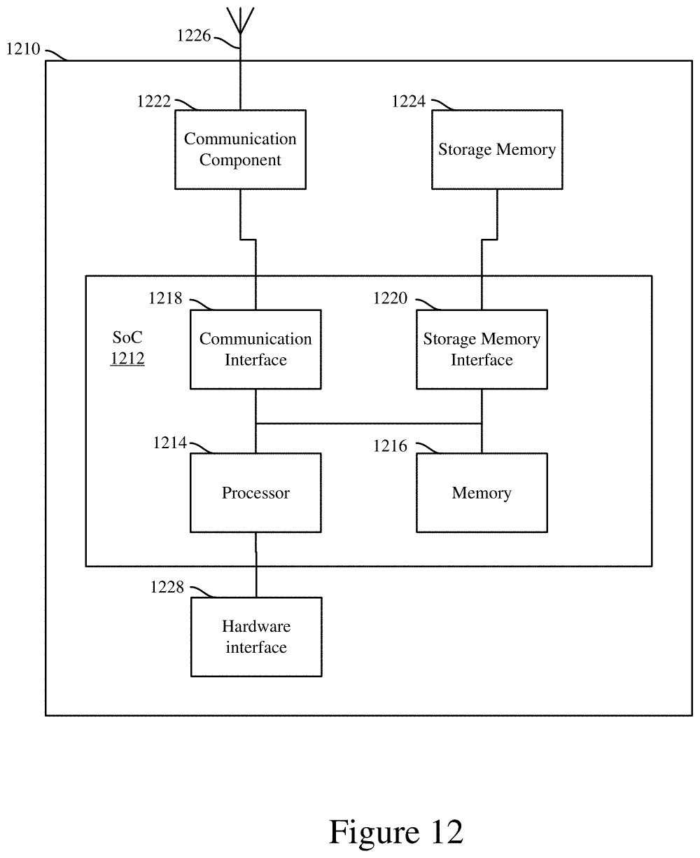

Various embodiments may be implemented within a processing device 1210 configured to be used in a robotic vehicle. A processing device may be configured as or including a system-on-chip (SoC) 1212, an example of which is illustrated in FIG. 12. With reference to FIGS. 1-12, the SoC 1212 may include (but is not limited to) a processor 1214, a memory 1216, a communication interface 1218, and a storage memory interface 1220. The processing device 1210 or the SOC 1212 may further include a communication component 1222, such as a wired or wireless modem, a storage memory 1224, an antenna 1226 for establishing a wireless communication link, and/or the like. The processing device 1210 or the SOC 1212 may further include a hardware interface 1228 configured to enable the processor 1214 to communicate with and control various components of a robotic vehicle. The processor 1214 may include any of a variety of processing devices, for example any number of processor cores.

The term “system-on-chip” (SoC) is used herein to refer to a set of interconnected electronic circuits typically, but not exclusively, including one or more processors (e.g., 1214), a memory (e.g., 1216), and a communication interface (e.g., 1218). The SoC 1212 may include a variety of different types of processors 1214 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 1212 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 1212 may include one or more processors 1214. The processing device 1210 may include more than one SoC 1212, thereby increasing the number of processors 1214 and processor cores. The processing device 1210 may also include processors 1214 that are not associated with an SoC 1212 (i.e., external to the SoC 1212). Individual processors 1214 may be multicore processors. The processors 1214 may each be configured for specific purposes that may be the same as or different from other processors 1214 of the processing device 1210 or SoC 1212. One or more of the processors 1214 and processor cores of the same or different configurations may be grouped together. A group of processors 1214 or processor cores may be referred to as a multi-processor cluster.

The memory 1216 of the SoC 1212 may be a volatile or non-volatile memory configured for storing data and processor-executable instructions for access by the processor 1214. The processing device 1210 and/or SoC 1212 may include one or more memories 1216 configured for various purposes. One or more memories 1216 may include volatile memories such as random access memory (RAM) or main memory, or cache memory.

Some or all of the components of the processing device 1210 and the SoC 1212 may be arranged differently and/or combined while still serving the functions of the various aspects. The processing device 1210 and the SoC 1212 may not be limited to one of each of the components, and multiple instances of each component may be included in various configurations of the processing device 1210.

The various processors described herein may be any programmable microprocessor, microcomputer or multiple processor chip or chips that can be configured by software instructions (applications) to perform a variety of functions, including the functions of various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable software, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read only memory (ROM), electrically erasable programmable ROM (EEPROM), FLASH memory, compact disc ROM (CD-ROM) or other optical disk storage, magnetic disk storage or other magnetic storage smart objects, or any other medium that may be used to store desired program code in the form of instructions or data structures and that may be accessed by a computer. Disk and disc, as used herein, includes CD, laser disc, optical disc, digital versatile disc (DVD), floppy disk, and Blu-ray disc where disks usually reproduce data magnetically, while discs reproduce data optically with lasers. Combinations of memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method for guiding a robotic vehicle through a course, comprising:
determining gate information for each of a plurality of gates that define the course, the gate information including at least a location, an ordering, and a pose of each gate;
determining a number of capabilities of a selected robotic vehicle;
generating an optimal trajectory through the course based on the determined gate information and the determined capabilities, the optimal trajectory including a reference path for the selected robotic vehicle to follow through the course; and
providing the optimal trajectory to the selected robotic vehicle.

2. The method of claim 1, wherein the optimal trajectory includes one or more of timing information, position information, velocity information, acceleration information, altitude information, pose information, and turning characteristics for the selected robotic vehicle.

3. The method of claim 1, wherein the number of capabilities of the selected robotic vehicle includes one or more of a battery life of the selected robotic vehicle, a maximum velocity of the selected robotic vehicle, a maximum altitude of the selected robotic vehicle, a maximum acceleration of the selected robotic vehicle, and turning characteristics of the selected robotic vehicle.

4. The method of claim 1, wherein each of the plurality of gates comprises:
an opening through which the robotic vehicles traverse during a race through the course; and
a fiducial marker configured to encode gate information for the corresponding gate.

5. The method of claim 1, wherein the optimal trajectory is defined as a function of time.

6. The method of claim 1, further comprising:
determining that the selected robotic vehicle has deviated from the optimal trajectory by more than a distance; and
providing navigation assistance to the selected robotic vehicle based at least in part on the determined deviation, the navigation assistance configured to cause the selected robotic vehicle to change one or more of its velocity, altitude, direction, pose, and turning characteristics so that the flight path of the selected robotic vehicle converges with the optimal trajectory.

7. The method of claim 6, wherein the optimal trajectory comprises a virtual tunnel oriented around the reference path and configured to indicate the distance that the selected robotic vehicle may deviate from various points along the reference path.

8. The method of claim 6, wherein providing the navigation assistance further comprises:
providing a first level of navigation assistance to the selected robotic vehicle based on a first type of race; and
providing a second level of navigation assistance, different than the first level of navigation assistance, to the selected robotic vehicle based on a second type of race.

9. The method of claim 8, wherein:
the first level of navigation assistance comprises assuming control of the selected robotic vehicle or causing the selected robotic vehicle to stop, land, or return home; and
the second level of navigation assistance comprises changing a velocity, altitude, direction, and/or pose of the selected robotic vehicle while allowing a pilot to retain at least some control of the selected robotic vehicle.

10. The method of claim 1, further comprising:
determining a skill level and one or more preferences of a pilot associated with the selected robotic vehicle; and
modifying the optimal trajectory based at least in part on the determined skill level and the preferences.

11. The method of claim 10, wherein the one or more preferences include at least one of a risk level of the pilot and a desired competitive level of the pilot.

12. The method of claim 1, further comprising:
detecting a presence of another robotic vehicle within a distance of the selected robotic vehicle; and
modifying the optimal trajectory based on the detected presence of the other robotic vehicle.

13. The method of claim 12, wherein the modified optimal trajectory is configured to avoid a collision between the selected robotic vehicle and the other robotic vehicle.

14. The method of claim 1, further comprising:
determining one or more race hazards; and
modifying the optimal trajectory based on the determined race hazards.

15. The method of claim 14, wherein the one or more race hazards include at least one of a crash on the course, a presence of obstacles on the course, and a change in capabilities of the selected robotic vehicle.

16. A system for guiding a robotic vehicle through a course, comprising:
one or more processors;
a memory comprising instructions that, when executed by the one or more processors, causes the system to perform operations including at least:
determining gate information for each of a plurality of gates that define the course, the gate information including at least a location, an ordering, and a pose of each gate;
determining a number of capabilities of a selected robotic vehicle; and
generating an optimal trajectory through the course based on the determined gate information and the determined capabilities, the optimal trajectory including a reference path for the selected robotic vehicle to follow through the course; and
a wireless transceiver coupled to the one or more processors and configured to transmit the optimal trajectory to the selected robotic vehicle.

17. The system of claim 16, wherein the optimal trajectory includes one or more of timing information, position information, velocity information, acceleration information, altitude information, pose information, and turning characteristics of the selected robotic vehicle.

18. The system of claim 16, wherein the number of capabilities of the selected robotic vehicle includes one or more of a battery life of the selected robotic vehicle, a maximum velocity of the selected robotic vehicle, a maximum altitude of the selected robotic vehicle, a maximum acceleration of the selected robotic vehicle, and turning characteristics of the selected robotic vehicle.

19. The system of claim 16, wherein each of the plurality of gates comprises:
an opening through which the robotic vehicles traverse during a race through the course; and
a fiducial marker configured to encode gate information for the corresponding gate.

20. The system of claim 16, wherein the optimal trajectory is defined as a function of time.

21. The system of claim 16, wherein execution of the instructions causes the system to perform operations further comprising:
determining that the selected robotic vehicle has deviated from the optimal trajectory by more than a distance; and
providing navigation assistance to the selected robotic vehicle based at least in part on the determined deviation, the navigation assistance configured to cause the selected robotic vehicle to change one or more of its velocity, altitude, direction, pose, and turning characteristics so that the flight path of the selected robotic vehicle converges with the optimal trajectory.

22. The system of claim 21, wherein the optimal trajectory comprises a virtual tunnel oriented around the reference path and configured to indicate the distance that the selected robotic vehicle may deviate from various points along the reference path.

23. The system of claim 21, wherein execution of the instructions for providing the navigation assistance causes the system to:
provide a first level of navigation assistance to the selected robotic vehicle based on a first type of race; and
provide a second level of navigation assistance, different than the first level of navigation assistance, to the selected robotic vehicle based on a second type of race while allowing a pilot to retain at least some control of the selected robotic vehicle.

24. The system of claim 23, wherein:
the first level of navigation assistance comprises assuming control of the selected robotic vehicle or causing the selected robotic vehicle to stop, land, or return home; and
the second level of navigation assistance comprises changing a velocity, altitude, direction, and/or pose of the selected robotic vehicle.

25. The system of claim 16, wherein execution of the instructions causes the system to perform operations further comprising:
determining a skill level and one or more preferences of a pilot associated with the selected robotic vehicle; and
modifying the optimal trajectory based at least in part on the determined skill level and the preferences.

26. The system of claim 25, wherein the one or more preferences include at least one of a risk level of the pilot and a desired competitive level of the pilot.

27. The system of claim 16, wherein execution of the instructions causes the system to perform operations further comprising:
detecting a presence of another robotic vehicle within a distance of the selected robotic vehicle; and
modifying the optimal trajectory based on the detected presence of the other robotic vehicle.

28. The system of claim 27, wherein the modified optimal trajectory is configured to avoid a collision between the selected robotic vehicle and the other robotic vehicle.

29. The system of claim 16, wherein execution of the instructions causes the system to perform operations further comprising:
determining one or more race hazards; and
modifying the optimal trajectory based on the determined race hazards.

30. The system of claim 29, wherein the one or more race hazards include at least one of a crash on the course, a presence of obstacles on the course, and a change in capabilities of the selected robotic vehicle.
